(19) United States
(12) Patent Application Publication
(10) Pub. No.: US 2026/0246278 A1
(43) Pub. Date: Aug. 20, 2026

(54) METHOD FOR DETERMINING AN ELECTRICITY CONSUMPTION STRATEGY BASED ON ELECTRICITY CONSUMPTION REGULATION CAPABILITIES OF MULTIPLE TYPES OF ENERGY DEVICES

(71) Applicants: ELECTRIC POWER SCIENCE & RESEARCH INSTITUTE OF STATE GRID TIANJIN ELECTRIC POWER COMPANY, Tianjin (CN); STATE GRID TIANJIN ELECTRIC POWER COMPANY, Tianjin (CN); STATE GRID CORPORATION OF CHINA, Beijing (CN)

(72) Inventors: Chao PANG, Tianjin (CN); Xianxu HUO, Tianjin (CN); Jiancheng YU, Tianjin (CN); Tao LIU, Tianjin (CN); Chun HE, Tianjin (CN); Zhishuang WANG, Tianjin (CN); Shiqian MA, Tianjin (CN); Jian ZHANG, Tianjin (CN); Chenyang ZHAO, Tianjin (CN); Kaiyuan JIN, Tianjin (CN)

(21) Appl. No.: 19/641,765

(22) Filed: Apr. 8, 2026

Related U.S. Application Data
(63) Continuation of application No. PCT/CN2026/071108, filed on Jan. 7, 2026.

(30) Foreign Application Priority Data
Nov. 12, 2024 (CN) 202411604191.2

(51) Int. Cl. H02J 3/32; B60L 53/51; B60L 53/63; B60L 53/68; B60L 55/00; H02J 3/38; H02J 101/24; H02J 103/35; H02J 105/52

(52) U.S. Cl. CPC H02J 3/322; B60L 53/51; B60L 53/63; B60L 53/68; B60L 55/00; H02J 3/381; H02J 2101/24; H02J 2103/35; H02J 2105/52

(57) ABSTRACT

A method includes: in response to receiving a power distribution regulation instruction from a power distribution network, acquiring type information of multiple energy devices within a target region, a target electricity consumption regulation period, and historical load information of the multiple energy devices; generating response power information of the multiple energy devices according to evaluation strategies for the electricity consumption regulation capabilities; aggregating the response power information of the multiple energy devices of the same type according to the type information to generate response power information of multiple energy subsystems; generating initial electricity consumption regulation capability information for the target region according to the response power information of the multiple energy subsystems and initial weights corresponding to the multiple energy subsystems; and generating the electricity consumption strategy for the target electricity consumption regulation period according to the response power information of the multiple energy devices.

### CROSS-REFERENCE TO RELATED APPLICATION

The present application is a continuation of International Patent Application No. PCT/CN2026/071108, filed on Jan. 7, 2026, which claims priority to Chinese Patent Application No. 202411604191.2 filed with the China National Intellectual Property Administration (CNIPA) on Nov. 12, 2024, the disclosures of which are incorporated herein by reference in their entireties.

### TECHNICAL FIELD

The present application relates to the field of integrated energy technology, for example, a method for determining an electricity consumption strategy based on electricity consumption regulation capabilities of multiple types of energy devices.

### BACKGROUND

The integrated energy system features numerous device types, diverse structures, significant differences between device parameters under a varying operating condition, and significant differences between sub-minute dynamic characteristics. Moreover, the control capabilities and behavioral uncertainties among different devices are coupled and constrained by multiple energy networks such as electricity, heat, and cooling. The evaluation of the control capabilities of the integrated energy system devices involves the coordination of control devices at multiple time scales and granularities, while different requirements of local renewable energy consumption, external grid regulation, and the green and low-carbon transformation of the energy system need to be considered.

Therefore, it is difficult to satisfy the minute-level dynamic regulation demands of the power grid.

### SUMMARY

The present application provides a method for determining an electricity consumption strategy based on electricity consumption regulation capabilities of multiple types of energy devices.

The present application provides a method for determining an electricity consumption strategy based on electricity consumption regulation capabilities of multiple types of energy devices. The method includes: in response to receiving a power distribution regulation instruction from a power distribution network, acquiring type information of multiple energy devices within a target region, a target electricity consumption regulation period, and historical load information of the multiple energy devices corresponding to the target electricity consumption regulation period; separately processing the historical load information of the multiple energy devices and the target electricity consumption regulation period according to evaluation strategies for the electricity consumption regulation capabilities corresponding to the type information to generate response power information of the multiple energy devices; aggregating the response power information of the multiple energy devices of the same type according to the type information to generate response power information of multiple energy subsystems; generating initial electricity consumption regulation capability information for the target region according to the response power information of the multiple energy subsystems and initial weights corresponding to the multiple energy subsystems; and in response to the initial electricity consumption regulation capability information satisfying a target constraint condition, generating the electricity consumption strategy for the target electricity consumption regulation period according to the response power information of the multiple energy devices, where the target constraint condition includes an electricity consumption safety constraint and a carbon emission constraint for the target region.

According to an embodiment of the present application, the step of separately processing the historical load information of the plurality of energy devices and the target electricity consumption regulation period according to the evaluation strategies for the electricity consumption regulation capabilities corresponding to the type information to generate the response power information of the plurality of energy devices includes: determining a target electricity consumption regulation duration according to the target electricity consumption regulation period; generating response power information of multiple photovoltaics, energy storage, direct current, and flexibility (PEDF) devices by processing the target electricity consumption regulation duration and historical load information of the multiple PEDF devices based on an evaluation strategy corresponding to the PEDF devices; generating response power information of multiple smart lighting devices by processing the target electricity consumption regulation duration and historical load information of the multiple smart lighting devices based on an evaluation strategy corresponding to the smart lighting devices; generating response power information of multiple thermal storage electric boiler devices by processing the target electricity consumption regulation duration and historical load information of the multiple thermal storage electric boiler devices based on an evaluation strategy corresponding to the thermal storage electric boiler devices; and generating response power information of multiple ground source heat pump devices by processing the target electricity consumption regulation duration and historical load information of the multiple ground source heat pump devices based on an evaluation strategy corresponding to the ground source heat pump devices.

According to an embodiment of the present application, the preceding method further includes: separately displaying the response power information of the multiple PEDF devices, the response power information of the multiple smart lighting devices, the response power information of the multiple thermal storage electric boiler devices, and the response power information of the multiple ground source heat pump devices through a visual interface.

According to an embodiment of the present application, the step of aggregating the response power information of the multiple energy devices of the same type according to the type information to generate the response power information of the multiple energy subsystems includes: aggregating response power information of multiple PEDF devices to generate response power information of PEDF subsystems; aggregating response power information of multiple smart lighting devices to generate response power information of smart lighting subsystems; aggregating response power information of multiple thermal storage electric boiler devices to generate response power information of thermal storage electric boiler subsystems; and aggregating response power information of multiple ground source heat pump devices to generate response power information of ground source heat pump subsystems.

According to an embodiment of the present application, the preceding method further includes: in response to the initial electricity consumption regulation capability information not satisfying the target constraint condition, adjusting the initial weights corresponding to the multiple energy subsystems until the target constraint condition is satisfied, thereby obtaining target weights; and generating target electricity consumption regulation capability information for the target region according to the target weights and the response power information of the multiple energy subsystems.

According to an embodiment of the present application, the preceding method further includes: acquiring current electricity transaction information and carbon emission factor information for the target region; and generating regulation resource consumption information by processing the target electricity consumption regulation capability information, the current electricity transaction information, and the carbon emission factor information.

According to an embodiment of the present application, in response to receiving an approval instruction for the regulation resource consumption information, sending feedback information to the power distribution network to indicate approval of accepting regulation; and adjusting operating power of the multiple energy devices according to the electricity consumption strategy so that the multiple energy devices operate normally during the target regulation period.

The present application further provides an apparatus for determining an electricity consumption strategy based on electricity consumption regulation capabilities of multiple types of energy devices. The apparatus includes a first acquisition module, a processing module, a first generation module, a second generation module, and a third generation module.

The first acquisition module is configured to, in response to receiving a power distribution regulation instruction from a power distribution network, acquire type information of multiple energy devices within a target region, a target electricity consumption regulation period, and historical load information of the multiple energy devices corresponding to the target electricity consumption regulation period. The processing module is configured to separately process the historical load information of the multiple energy devices and the target electricity consumption regulation period according to evaluation strategies for the electricity consumption regulation capabilities corresponding to the type information to generate response power information of the multiple energy devices. The first generation module is configured to aggregate the response power information of the multiple energy devices of the same type according to the type information to generate response power information of multiple energy subsystems. The second generation module is configured to generate initial electricity consumption regulation capability information for the target region according to the response power information of the multiple energy subsystems and initial weights corresponding to the multiple energy subsystems. The third generation module is configured to, in response to the initial electricity consumption regulation capability information satisfying a target constraint condition, generate the electricity consumption strategy for the target electricity consumption regulation period according to the response power information of the multiple energy devices, where the target constraint condition includes an electricity consumption safety constraint and a carbon emission constraint for the target region.

The present application further provides an electronic device. The electronic device includes one or more processors and a memory configured to store one or more computer programs. The one or more processors execute the one or more computer programs to perform the steps of the preceding method.

The present application further provides a computer-readable storage medium configured to store a computer program which, when executed by a processor, causes the processor to perform the preceding method.

### BRIEF DESCRIPTION OF DRAWINGS

FIG. 1 is an application scenario view of a method for determining an electricity consumption strategy based on electricity consumption regulation capabilities of multiple types of energy devices according to an embodiment of the present application.

FIG. 2 is a flowchart of a method for determining an electricity consumption strategy based on electricity consumption regulation capabilities of multiple types of energy devices according to an embodiment of the present application.

FIG. 3 is a flowchart of generating target electricity consumption regulation capability information for a target region according to an embodiment of the present application.

FIG. 4 is a flowchart of determining an electricity consumption strategy of multiple energy devices based on regulation resource consumption information according to an embodiment of the present application.

FIG. 5 is a block diagram of an apparatus for determining an electricity consumption strategy based on electricity consumption regulation capabilities of multiple types of energy devices according to an embodiment of the present application.

FIG. 6 is a block diagram of an electronic device for a method for determining an electricity consumption strategy based on electricity consumption regulation capabilities of multiple types of energy devices according to an embodiment of the present application.

### DETAILED DESCRIPTION

Embodiments of the present application are described hereinafter with reference to the drawings. These descriptions are merely exemplary and are not intended to limit the scope of the present application. In the following description, numerous details are set forth for the purpose of explanation to provide a thorough understanding of the embodiments of the present application. However, one or more embodiments may be implemented without these details. In addition, in the following description, descriptions of well-known structures and techniques are omitted to avoid unnecessarily obscuring the concepts of the present application.

The terms used herein are merely for the purpose of describing the embodiments and are not intended to limit the present application. As used herein, the terms “including”, “comprising”, and the like indicate the presence of the features, steps, operations, and/or components, but do not exclude the presence or addition of one or more other features, steps, operations, or components.

All terms used herein, including technical and scientific terms, have the meanings commonly understood by those skilled in the art, unless otherwise defined. It is to be noted that the terms used herein should be interpreted as having meanings consistent with the context of this specification, rather than being interpreted in an idealized or overly rigid manner.

When expressions such as “at least one of A, B, and C” are used, the expressions should generally be interpreted in accordance with the meanings commonly understood by those skilled in the art (for example, “a system having at least one of A, B, and C” should include a system having A alone, a system having B alone, a system having C alone, a system having A and B, a system having A and C, a system having B and C, and/or a system having A, B, and C).

The electric power demand response is a flexible and fast-acting measure that can affect the electricity prices and system operation in a short term. With the accelerated development of integrated energy technologies and engineering construction, the trend toward energy diversification has become increasingly prominent, and the integrated demand response based on the electric power demand response has emerged accordingly. To ensure the reliability and flexibility of an integrated energy system in a target region participating in dynamic regulation of the power grid, it is necessary to model the integrated energy system of the target region and to perform hierarchical aggregation and evaluation.

Currently, a variety of methods for evaluating the regulation capability of the integrated energy system in the target region have been proposed. Among these methods, the evaluation method based on an optimal scheduling algorithm has been widely applied. For example, the optimal scheduling strategy based on linear programming, dynamic programming, and the like has been widely applied to the scheduling and optimal operation of the integrated energy system in the target region. In addition, deep reinforcement learning algorithms and methods involving practical operational experiments have also achieved certain results in evaluating the regulation capability of the integrated energy system in the target region.

Accurate evaluation of the regulation capabilities of heterogeneous energy devices and energy networks in the target region is the foundation for enabling the integrated energy system in the target region to support dynamic regulation of the external power grid and to optimize the stable operation of the internal energy network. However, the integrated energy system in the target region features numerous device types, diverse structures, significant differences between device parameters under a varying operating condition, and significant differences between sub-minute dynamic characteristics. Moreover, the control capabilities and behavioral uncertainties among different devices are coupled and constrained by multiple energy networks such as electricity, heat, and cooling. The evaluation of the control capabilities of the integrated energy system devices involves the coordination of control devices at multiple time scales and granularities. Moreover, different requirements of local renewable energy consumption, external grid regulation, and the green and low-carbon transformation of the energy system need to be considered.

Therefore, it is difficult for the existing method that simply superimposes different types of devices for evaluation to accurately evaluate the reliable regulation capability. In addition, research on evaluating and aggregating the structural characteristics and regulation performance of different types of devices in the integrated energy system at different levels and on characterizing evaluation criteria at different levels in conjunction with schedulable electrical devices in the target region remains relatively limited. Therefore, it is difficult to satisfy the minute-level dynamic regulation demands of the power grid.

Based on this, it is necessary to hierarchically aggregate and evaluate the interaction effects and electricity consumption regulation capabilities of the subsystems on the basis of considering the local power grid safety constraint, the carbon constraint condition, structural characteristics of heterogeneous energy devices, and different types of devices coupled with characteristics of energy networks.

In view of the preceding problems, the embodiments of the present application provide a method for determining an electricity consumption strategy based on electricity consumption regulation capabilities of multiple types of energy devices. After receiving a power distribution regulation instruction from a power distribution network, type information of multiple energy devices within a target region, a target electricity consumption regulation period, and historical load information of the energy devices corresponding to the target electricity consumption regulation period are acquired to generate response power information of the energy devices. The energy devices of the same type are aggregated to generate response power information of energy subsystems. Through hierarchical aggregation and evaluation of heterogeneous energy devices and energy networks in the integrated energy system in the target region, interference caused by differences among energy device types in the evaluation of the overall electricity consumption regulation capability is reduced. Finally, initial electricity consumption regulation capability information for the target region that satisfies a target constraint condition is generated, and the electricity consumption strategy for the target electricity consumption regulation period is generated. In this manner, the minute-level dynamic regulation demands of the power distribution network are satisfied, and the safe operation of energy devices in the target region during the electricity consumption regulation period of the power distribution network can be ensured.

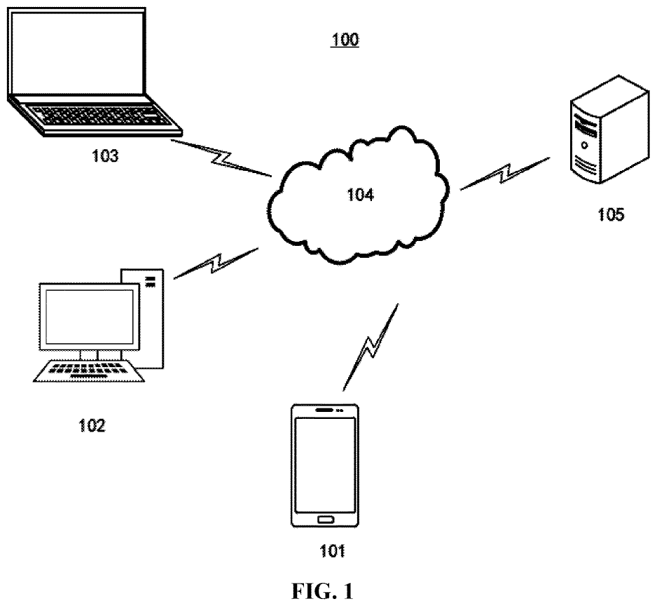

FIG. 1 is an application scenario view of a method for determining an electricity consumption strategy based on electricity consumption regulation capabilities of multiple types of energy devices according to an embodiment of the present application.

As shown in FIG. 1, an application scenario 100 according to this embodiment may include a first terminal device 101, a second terminal device 102, a third terminal device 103, a network 104, and a server 105.

The network 104 is configured to be a medium for providing communication links among the first terminal device 101, the second terminal device 102, the third terminal device 103, and the server 105. The network 104 may include multiple connection types, such as wired communication links, wireless communication links, or fiber-optic cables.

The user may use the first terminal device 101, the second terminal device 102, and the third terminal device 103 to interact with the server 105 through the network 104 to receive or send messages. The first terminal device 101, the second terminal device 102, and the third terminal device 103 may be equipped with various communication client applications, such as shopping applications, web browser applications, search applications, instant messaging tools, email clients, and social platform software (for illustrative purposes only).

The first terminal device 101, the second terminal device 102, and the third terminal device 103 may be various electronic devices having display screens and supporting web browsing, including smartphones, tablet computers, laptop computers, desktop computers, and the like.

The server 105 may be a server providing various services, for example, a backend management server configured to support websites accessed by the user via the first terminal device 101, the second terminal device 102, and the third terminal device 103 (for illustrative purposes only). The backend management server may analyze and process data such as received user requests and feed back processing results (for example, webpages, information, or data acquired or generated according to the user requests) to the terminal devices.

The method for determining an electricity consumption strategy based on electricity consumption regulation capabilities of multiple types of energy devices provided in the embodiments of the present application may generally be performed by the server 105. Correspondingly, an apparatus for determining an electricity consumption strategy based on electricity consumption regulation capabilities of multiple types of energy devices provided in the embodiment of the present application may generally be deployed in the server 105. The method for determining an electricity consumption strategy based on electricity consumption regulation capabilities of multiple types of energy devices provided in the embodiments of the present application may also be performed by a server or a server cluster different from the server 105 and capable of communicating with the first terminal device 101, the second terminal device 102, the third terminal device 103, and/or the server 105. Correspondingly, the apparatus for determining an electricity consumption strategy based on electricity consumption regulation capabilities of multiple types of energy devices provided in the embodiment of the present application may also be deployed in a server or a server cluster different from the server 105 and capable of communicating with the first terminal device 101, the second terminal device 102, the third terminal device 103, and/or the server 105.

The number of terminal devices, the number of networks, and the number of servers in FIG. 1 are merely illustrative. Depending on implementation requirements, any number of terminal devices, networks, and servers may be provided.

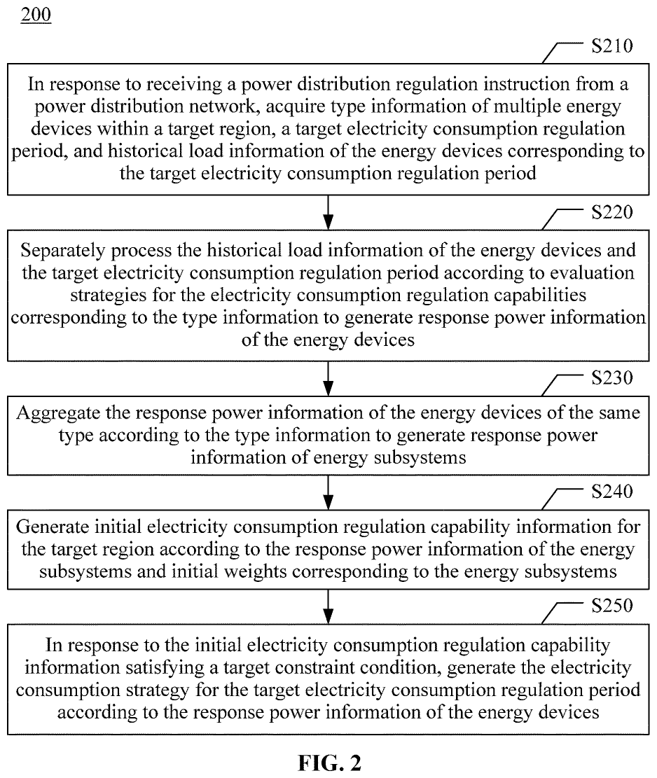

The method for determining an electricity consumption strategy based on electricity consumption regulation capabilities of multiple types of energy devices provided in the embodiments of the present application is described based on the scenario in FIG. 1 with reference to FIGS. 2 to 4.

FIG. 2 is a flowchart of a method for determining an electricity consumption strategy based on electricity consumption regulation capabilities of multiple types of energy devices according to an embodiment of the present application.

As shown in FIG. 2, a method 200 for determining an electricity consumption strategy based on electricity consumption regulation capabilities of multiple types of energy devices in this embodiment includes operations S210 to S250.

In operation S210, in response to receiving a power distribution regulation instruction from a power distribution network, type information of multiple energy devices within a target region, a target electricity consumption regulation period, and historical load information of the energy devices corresponding to the target electricity consumption regulation period are acquired. At least one energy device may be provided.

The load information refers to a data set related to the past operation of devices that is collected and analyzed by the system after receiving the regulation instruction from the power distribution network, for the purpose of evaluating regulation capabilities of multiple energy devices in the target region. The load information may be considered to include, but is not limited to, the following aspects: 1. historical power data of devices, such as historical load curves and power variation trends; 2. device operation state parameters, such as historical photovoltaic power generation data, historical energy storage system data, historical data of vehicle-to-grid (V2G) charging piles, and historical operation state parameters of devices; 3. device regulation characteristic data, such as whether a device allows short-term interruption of operation, whether a device load can be shifted over time, and response time of device regulation; 4. data corresponding to time and environment, such as meteorological data and electricity consumption scenarios (for example, working days, holidays, peak periods, and off-peak periods).

In operation S220, the historical load information of the energy devices and the target electricity consumption regulation period are separately processed according to evaluation strategies for the electricity consumption regulation capabilities corresponding to the type information to generate response power information of the energy devices.

An evaluation strategy refers to a set of mathematical calculation rules that is predesigned for a specific type of electrical device and based on its operating principles. The set of rules takes historical operating data of the device and external regulation demands as inputs, and outputs, through calculation, a quantified and executable power regulation capability value. In general, the evaluation strategy is a calculation method that takes historical load information of the device and external regulation information as inputs, and outputs response power information.

In operation S230, the response power information of the energy devices of the same type is aggregated according to the type information to generate response power information of energy subsystems. At least one energy subsystem may be provided.

In operation S240, initial electricity consumption regulation capability information for the target region is generated according to the response power information of the energy subsystems and initial weights corresponding to the energy subsystems.

In operation S250, in response to the initial electricity consumption regulation capability information satisfying a target constraint condition, the electricity consumption strategy for the target electricity consumption regulation period is generated according to the response power information of the energy devices.

The electricity consumption strategy is a specific and executable set of scheduling instructions. The electricity consumption strategy is a final operational scheme generated after the preliminary evaluation results have passed validation. The electricity consumption strategy has the following characteristics: 1. the strategy is neither evaluation data nor a theoretical value, but a set of explicit operational instructions; 2. for each specific energy device participating in regulation within the target region, the strategy clearly specifies operational details of the device during the target electricity consumption regulation period (starting from time t and lasting for a duration D).

According to the embodiments of the present application, the power distribution regulation instruction is sent by the power distribution network. For example, “an electricity consumption regulation operation is performed at time t with a regulation duration of 1 h”.

Currently, the energy network in the target region is generally composed of a PEDF system, a ground source heat pump system, a thermal storage electric boiler system, a photovoltaic power generation system, a solar water heating system, a base load chiller unit, an ice storage cooling system, a solar air conditioning system, and a smart lighting system. Subsystems that possess significant potential for fast and dynamic regulation while being difficult to quantitatively evaluate mainly include the PEDF system, the smart lighting system, the thermal storage electric boiler system, and the ground source heat pump system. Therefore, in the present application, the type information of the multiple energy devices in the target region includes PEDF devices, smart lighting devices, thermal storage electric boiler devices, and ground source heat pump devices.

The target electricity consumption regulation period includes a target electricity consumption regulation moment and a target electricity consumption regulation duration.

Historical load information of the energy devices corresponding to the target electricity consumption regulation period includes historical load information of the PEDF devices, historical load information of the lighting devices, historical load information of the thermal storage electric boiler devices, and historical load information of the ground source heat pump devices and is used for generating the response power information of the energy devices. By collecting historical load monitoring data of devices, historical load curves may be established, thereby analyzing electricity consumption patterns and load characteristics of the devices. The power of the energy devices is calculated using the historical load information corresponding to the target electricity consumption regulation period. In addition, the historical load information of the energy devices is conducive to the identification of interruptible characteristics and transferable characteristics of the devices, thereby determining interruption intervals and transferable intervals, that is, determining the target electricity consumption regulation moment and the target electricity consumption regulation duration.

Evaluation strategies for the electricity consumption regulation capabilities corresponding to the type information include an evaluation strategy corresponding to the PEDF devices, an evaluation strategy corresponding to the smart lighting devices, an evaluation strategy corresponding to the thermal storage electric boiler devices, and an evaluation strategy corresponding to the ground source heat pump devices. Based on the evaluation strategies for the electricity consumption regulation capabilities, historical load information of the energy devices and the target electricity consumption regulation period are separately processed to generate the response power information of the energy devices.

To evaluate structural characteristics and regulation performance of different types of devices in the integrated energy system at different levels, the response power information of the energy devices of the same type is aggregated to generate the response power information of the energy subsystems, thereby achieving hierarchical aggregation and evaluation of heterogeneous energy devices and energy networks in the integrated energy system in the target region.

Initial weights corresponding to the energy subsystems are initial configuration parameters and may be adjusted according to requirements of the target constraint condition. For example, the initial weights may be 0.2, 0.3, 0.6, and the like. The initial electricity consumption regulation capability information for the target region represents the adjustable power information of the energy devices in respective operation states of the energy subsystems.

The target constraint condition includes an electricity consumption safety constraint and a carbon emission constraint for the target region. When the initial electricity consumption regulation capability information satisfies the target constraint condition, electricity consumption regulation is performed during the target electricity consumption regulation period according to the response power information of the energy devices in this case.

According to the embodiment of the present application, after receiving a power distribution regulation instruction from a power distribution network, type information of multiple energy devices within a target region, a target electricity consumption regulation period, and historical load information of the energy devices corresponding to the target electricity consumption regulation period are acquired. Response power information of the energy devices is generated. The energy devices of the same type are aggregated to generate response power information of energy subsystems. Through hierarchical aggregation and evaluation of heterogeneous energy devices and energy networks in the integrated energy system in the target region, interference caused by differences among energy device types in the evaluation of the overall electricity consumption regulation capability is reduced. Finally, initial electricity consumption regulation capability information for the target region that satisfies a target constraint condition is generated, and the electricity consumption strategy for the target electricity consumption regulation period is generated. In this manner, the minute-level dynamic regulation demands of the power distribution network are satisfied, and the safe operation of energy devices in the target region during the electricity consumption regulation period of the power distribution network can be ensured.

According to the embodiment of the present application, the step of separately processing the historical load information of the energy devices and the target electricity consumption regulation period according to the evaluation strategies for the electricity consumption regulation capabilities corresponding to the type information to generate the response power information of the energy devices includes: determining a target electricity consumption regulation duration according to the target electricity consumption regulation period; generating response power information of PEDF devices by processing the target electricity consumption regulation duration and historical load information of the PEDF devices based on an evaluation strategy corresponding to the PEDF devices; generating response power information of smart lighting devices by processing the target electricity consumption regulation duration and historical load information of the lighting devices based on an evaluation strategy corresponding to the smart lighting devices; generating response power information of thermal storage electric boiler devices by processing the target electricity consumption regulation duration and historical load information of the thermal storage electric boiler devices based on an evaluation strategy corresponding to the thermal storage electric boiler devices; and generating response power information of ground source heat pump devices by processing the target electricity consumption regulation duration and historical load information of the ground source heat pump devices based on an evaluation strategy corresponding to the ground source heat pump devices. At least one PEDF device may be provided, at least one smart lighting device may be provided, at least one thermal storage electric boiler device may be provided, and at least one ground source heat pump device may be provided.

According to the embodiment of the present application, considering the mutual interactions among individual devices during operation and regulation processes, hierarchical quantitative evaluation of regulation capabilities of the devices is first performed, and electricity consumption regulation capabilities of the devices are evaluated at a device level.

Based on the evaluation strategy corresponding to the PEDF devices, the response power information of the PEDF devices is calculated. The PEDF system is an integrated power system that integrates photovoltaic power generation, the energy storage system, direct current power distribution technologies, and flexible electricity consumption technologies. By deploying such a system, efficient utilization of renewable energy can be achieved in the target region, while the stability and flexibility of the power system in the target region can be improved. The PEDF system includes a photovoltaic power generation system, an energy storage system, and a V2G charging pile.

Photovoltaic power generation is the technology that directly converts solar energy into electrical energy by using the photovoltaic effect. The photovoltaic power generation system mainly includes a photovoltaic assembly, an inverter, and a battery energy storage and support system. The photovoltaic assembly converts solar radiation into direct current power, and the inverter converts the direct current power into alternating current power for production and consumption in the target region. When the target region participates in grid regulation, the photovoltaic power output is calculated according to formula (1) and formula (2) below.

$${P}_{pv} ( t ) = min ( {P}_{pv , max} , G \cdot A \cdot η ) \qquad ( 1 )$$

$${R}_{pv} ( t , D ) = \frac{1}{D} {\int }_{t}^{t + D} {P}_{pv} ( t ) dt \qquad ( 2 )$$

Pₚᵥ(t) denotes the photovoltaic power output and is expressed in kW; G denotes the solar radiation intensity and is expressed in kW/m²; A denotes the effective area of the photovoltaic panel and is expressed in m²; η denotes the conversion efficiency of the photovoltaic panel; P_{pv,max} denotes the maximum photovoltaic power output and is expressed in kW; D denotes the target electricity consumption regulation duration and is expressed in s; t denotes the target electricity consumption regulation moment; and Rₚᵥ(t,D) denotes the average photovoltaic power output during the target electricity consumption regulation duration D and is expressed in kW.

The charging and discharging process is the core of the operation of the energy storage system and determines the application effectiveness of the energy storage system in grid regulation, renewable energy integration, and the backup power supply. When the target region participates in grid regulation, the energy storage power is calculated according to formula (3), formula (4), and formula (5) below.

$${P}_{b , c} ( t ) = min ( {P}_{b , c , max} , {P}_{pv} ( t ) - {P}_{load} ( t ) ) \qquad ( 3 )$$

$${P}_{b , d} ( t ) = min ( {P}_{b , d , max} , {P}_{load} ( t ) - {P}_{pv} ( t ) ) \qquad ( 4 )$$

$${R}_{b} ( t , D ) = \frac{1}{D} {\int }_{t}^{t + D} ( {P}_{b , c} ( t ) - {P}_{b , d} ( t ) ) dt \qquad ( 5 )$$

P_{b,c}(t) denotes the charge power of the energy storage system and is expressed in kW; P_{b,d}(t) denotes the discharge power of the energy storage system and is expressed in kW; P_{b,c,max} denotes the maximum charge power of the energy storage system and is expressed in kW; P_{b,d,max} denotes the maximum discharge power of the energy storage system and is expressed in kW; P_{load}(t) denotes the load power at moment t and is expressed in kW; and R_{b}(t,D) denotes the average power of the energy storage system during the target electricity consumption regulation duration D and is expressed in kW.

The dynamic equation for the battery energy is shown in formula (6) below.

$$\frac{{dE}_{b} ( t )}{dt} = {η}_{b , c} {P}_{b , c} ( t ) - {η}_{b , d} {P}_{b , d} ( t ) - {Q}_{loss} ( t ) \qquad ( 6 )$$

E_{b}(t) denotes the stored energy and is expressed in kWh; η_{b,c} denotes the battery charging efficiency and is expressed in kW; η_{b,d} denotes the battery discharging efficiency and is expressed in kW; and Qₗₒₛₛ(t) denotes the heat loss of the energy storage system at moment t and is expressed in kW.

The V2G charging pile is an advanced form of an electric vehicle charging system, which allows an electric vehicle not only to draw electrical energy from the power grid for charging, but also to feed the stored electrical energy back to the power grid. Such bidirectional charging technology not only contributes to the stability of the power grid, but also provides additional economic benefits for electric vehicle owners. When the target region participates in grid regulation, the charge and discharge power of the charging pile is calculated according to formula (7), formula (8), and formula (9) below.

$${P}_{c} ( t ) = max ( 0 , min ( {P}_{c , max} , {P}_{v 2 g , charge} ( t ) ) ) \qquad ( 7 )$$

$${P}_{d} ( t ) = max ( 0 , min ( {P}_{d , max} , {P}_{v 2 g , discharge} ( t ) ) ) \qquad ( 8 )$$

$${P}_{V 2 G} ( t , D ) = \frac{1}{D} {\int }_{t}^{t + D} ( {P}_{d} ( t ) - {P}_{c} ( t ) ) dt \qquad ( 9 )$$

P_{c}(t) denotes the charge power of the charging pile to the electric vehicle and is expressed in kW; P_{d}(t) denotes the discharge power of the electric vehicle to the power grid and is expressed in kW; P_{c,max} denotes the maximum charge power of the charging pile to the electric vehicle and is expressed in kW; P_{d,max} denotes the maximum discharge power of the electric vehicle to the power grid and is expressed in kW; P_{v2g,charge}(t) denotes the allowed charge power of the vehicle at moment t and is expressed in kW; P_{v2g,discharge}(t) denotes the allowed discharge power of the vehicle at moment t and is expressed in kW; and R_{V2G}(t,D) denotes the average power of the charging pile during the target electricity consumption regulation duration D and is expressed in kW.

By integrating the photovoltaic power generation system, the energy storage system, and the V2G system, the overall regulation capability of the PEDF device is calculated, and the overall electricity consumption regulation power is calculated according to formula (10) below.

$$f ( {E}_{b} , {R}_{pv} , {R}_{b} , {R}_{V 2 G} , t , D ) = min ( {R}_{pv} ( t , D ) + {R}_{b} ( t , D ) + {R}_{V 2 G} ( t , D ) ) \qquad ( 10 )$$

The smart lighting system may intelligently adjust the lighting intensity and usage time, thereby achieving energy saving and consumption reduction while extending the service life of the device. Response power information of smart lighting devices is generated by processing the target electricity consumption regulation duration and historical load information of the lighting devices based on an evaluation strategy corresponding to the smart lighting devices. When the target region participates in grid regulation, the calculation method for the power of the smart lighting device is shown according to formula (11) and formula (12) below.

$${P}_{light} ( t ) = min ( {P}_{light , max} , {D}_{light} ( t ) ( \frac{{L}_{current} ( t )}{{L}_{max}} \cdot {F}_{demand} ( t ) \cdot {F}_{zchedule} ( t ) ) \qquad ( 11 )$$

$${P}_{light} ( t , D ) = \frac{1}{D} {\int }_{t}^{t + D} {P}_{light} ( t ) dt \qquad ( 12 )$$

P_{light}(t) denotes the lighting power at moment t and is expressed in kW; P_{light}, max denotes the maximum power of the light and is expressed in kW; D_{light}(t) denotes the lighting demand at moment t and is expressed in kW; L_{current}(t) denotes the actual luminous intensity at moment t and is expressed in lm; Lₘₐₓ denotes the maximum luminous intensity of the light and is expressed in lm; F_{demand}(t) denotes the demand response coefficient (dimensionless) at moment t, indicating the degree of the grid load response; F_{schedule}(t) denotes the time scheduling factor (dimensionless) at moment t, for example, indicating 1 during working hours and indicating 0.5 during idle hours; and R_{light}(t,D) denotes the average power of the smart lighting device during the target electricity consumption regulation duration D and is expressed in kW.

The demand response power adjustment of the system refers to adjusting system power to respond to real-time conditions and demand variations of the power grid, thereby optimizing the grid operation and improving the system stability. When the target region participates in grid regulation, the demand response power is adjusted according to formula (13) below.

$${P}_{demand\_response} ( t , D ) = {P}_{current} ( t ) - {R}_{light} ( t , D ) \qquad ( 13 )$$

P_{demand_response}(t,D) denotes the demand response power at moment t and is expressed in kW; and P_{current}(t) denotes the actual lighting power at moment t and is expressed in kW.

The time-scheduled power refers to power that is adjusted across different time periods based on variations in the power demand and electricity price in the target region to optimize power consumption and reduce costs. When the target region participates in grid regulation, the time-scheduled power of the smart lighting system is shown by formula (14) below.

$${P}_{schedule\_adjusted} ( t , D ) = {P}_{demand\_response} ( t , D ) \cdot {F}_{schedule} ( t ) \qquad ( 14 )$$

P_{schedule_adjusted}(t,D) denotes the power adjusted according to the time schedule at moment t and is expressed in kW.

The thermal storage electric boiler system is a heating system that utilizes electrical energy to generate and store heat, which can be released when needed. This system is particularly suitable for load balancing and energy saving during periods of the unstable power supply or peak electricity prices. Response power information of thermal storage electric boiler devices is generated by processing the target electricity consumption regulation duration and historical load information of the thermal storage electric boiler devices based on an evaluation strategy corresponding to the thermal storage electric boiler devices. When the target region participates in grid regulation, the power and thermal storage capability of the thermal storage electric boiler device are shown by formula (15), formula (16), and formula (17) below.

$${P}_{boiler} ( t ) = min ( {P}_{boiler , max} , {P}_{demand} ( t ) ) \qquad ( 15 )$$

$${P}_{demand} ( t ) = max ( 0 , \frac{( {T}_{target} - {T}_{env} ( t ) \cdot {C}_{load}}{{η}_{boiler}} - {E}_{boiler} ( t ) \cdot \frac{1}{{η}_{boiler}} ) \qquad ( 16 )$$

$${R}_{boiler} ( t , D ) = \frac{1}{D} {\int }_{t}^{t + D} {P}_{boiler} ( t ) dt \qquad ( 17 )$$

P_{boiler}(t) denotes the power of the electric boiler at moment t and is expressed in kW; P_{boiler,max} denotes the maximum power output of the boiler and is expressed in kW; P_{demand}(t) denotes the heat load demand of the electric boiler and is expressed in kW; T_{target} denotes the desired indoor temperature and is expressed in degrees Celsius; Tₑₙᵥ(t) denotes the environmental temperature at moment t and is expressed in degrees Celsius; C_{load} denotes the load heat capacity and is expressed in kWh/degree; η_{boiler} denotes the thermal efficiency of the boiler; E_{boiler}(t) denotes the stored heat at moment t and is expressed in kWh; and R_{boiler}(t,D) denotes the average power of the thermal storage electric boiler device during the target electricity consumption regulation duration D and is expressed in kW.

The ground source heat pump can utilize the stable temperature of shallow soil or groundwater to provide heating and cooling, serving as an efficient system for heating and cooling. The response power information of the ground source heat pump devices is generated by processing the target electricity consumption regulation duration and the historical load information of the ground source heat pump devices based on the evaluation strategy corresponding to the ground source heat pump devices. When the target region participates in grid regulation, the power of the ground source heat pump device is calculated according to formula (18), formula (19), formula (20), and formula (21).

$${Q}_{demand} ( t ) = {C}_{load} \cdot Δ T ( t ) \qquad ( 18 )$$

$${P}_{pump} ( t ) = min ( {P}_{pump , max} , \frac{{Q}_{demand} ( t )}{COP ( {T}_{env} ( t ) , {T}_{out} ( t ) )} ) \qquad ( 19 )$$

$$COP ( {T}_{env} ( t ) , {T}_{out} ( t ) ) = \frac{{T}_{out} ( t )}{{T}_{out} ( t ) - {T}_{env} ( t )} \qquad ( 20 )$$

$${R}_{pump} ( t , D ) = \frac{1}{D} {\int }_{t}^{t + D} {P}_{pump} ( t ) dt \qquad ( 21 )$$

Q_{demand}(t) denotes the heat load demand at moment t and is expressed in kW; C_{load} denotes the load heat capacity and is expressed in kWh/degree; ΔT(t) denotes the difference between the target temperature and the environmental temperature at moment t and is expressed in degrees Celsius; COP(Tₑₙᵥ(t), Tₒᵤₜ(t)) denotes the performance coefficient of the heat pump; Pₚᵤₘₚ(t) denotes the power of the heat pump at moment t and is expressed in kW; P_{pump,max} denotes the maximum power of the heat pump and is expressed in kW; Rₚᵤₘₚ(t,D) denotes the average power of the ground source heat pump device during the target electricity consumption regulation duration D and is expressed in kW; Tₑₙᵥ(t) denotes the environmental temperature at moment t and is expressed in degrees Celsius; and Tₒᵤₜ(t) denotes the output temperature of the heat pump at moment t and is expressed in degrees Celsius.

The dynamic thermal storage capability is shown by formula (22) below.

$$\frac{{dE}_{pump} ( t )}{dt} = {η}_{pump} \cdot {P}_{pump} ( t ) - {Q}_{loss , pump} ( t ) \qquad ( 22 )$$

Eₚᵤₘₚ(t) denotes the stored heat at moment t and is expressed in kWh; ηₚᵤₘₚ denotes the efficiency of the heat pump; and Q_{loss,pump}(t) denotes the heat loss at moment t and is expressed in kW.

According to the embodiment of the present application, the response power information of the PEDF devices, the smart lighting devices, the thermal storage electric boiler devices, and the ground source heat pump devices is generated by processing the target electricity consumption regulation duration and the historical load information of the energy devices based on the evaluation strategies for the electricity consumption regulation capabilities corresponding to the type information. In this manner, the electricity consumption regulation capabilities of the devices can be evaluated at a device level, the regulation capabilities of different types of devices can be quantified, and the regulation capabilities of heterogeneous energy devices and energy networks in the target region can be accurately evaluated, thereby obtaining the electricity consumption strategy for the target electricity consumption regulation period.

According to an embodiment of the present application, the response power information of the PEDF devices, the response power information of the smart lighting devices, the response power information of the thermal storage electric boiler devices, and the response power information of the ground source heat pump devices are separately displayed through a visual interface.

According to the embodiment of the present application, since the regulation capabilities of the energy devices in the target region vary under different target electricity consumption regulation moments and different target electricity consumption regulation durations, the response power information of the energy devices is displayed through the visual interface, thereby displaying the performance of the subsystems formed by the energy devices under different configurations. The visual interface is implemented by means of a three-dimensional regulation capability surface plot, which is a three-dimensional surface plot with the target electricity consumption regulation moment, the target electricity consumption regulation duration, and the response power of the energy devices as variables.

The three-dimensional regulation capability surface plot of the PEDF device involves the overall regulation capability of the photovoltaic power generation system, the energy storage system, and the V2G system. Based on the appropriate selection of the photovoltaic power output Rₚᵥ(t), the power R_{b} of the energy storage system, and the V2G charge and discharge power R_{V2G}, the three-dimensional regulation capability surface plot of the PEDF system is drawn with the target electricity consumption regulation moment, the target electricity consumption regulation duration, and the overall electricity consumption regulation power of the PEDF device f(E_{b}, Rₚᵥ, R_{b}, R_{V2G}, t, D) as variables.

The three-dimensional regulation capability surface plot of the smart lighting device involves parameters such as the lighting intensity L, the time scheduling factor F_{schedule}, and the demand response coefficient F_{demand}(t). Based on the appropriate selection of parameter ranges, the three-dimensional regulation capability surface plot of the smart lighting system is drawn with the target electricity consumption regulation moment, the target electricity consumption regulation duration, and the power P_{schedule_adjusted}(t,D) adjusted according to the time schedule as variables.

The three-dimensional regulation capability surface plot of the thermal storage electric boiler device involves parameters such as the thermal storage state E (t), the environmental temperature Tₑₙᵥ(t), and the power P_{boiler}(t) of the electric boiler. Based on the appropriate selection of parameter ranges, the three-dimensional regulation capability surface plot of the thermal storage electric boiler system is drawn with the target electricity consumption regulation moment, the target electricity consumption regulation duration, and the power R_{boiler}(t,D) of the thermal storage electric boiler system as variables.

The three-dimensional regulation capability surface plot of the ground source heat pump system involves parameters such as the environmental temperature Tₑₙᵥ(t), the output temperature Tₒᵤₜ(t) of the heat pump, and the actual power Pₚᵤₘₚ(t). Based on the appropriate selection of parameter ranges, the three-dimensional regulation capability surface plot of the ground source heat pump system is drawn with the target electricity consumption regulation moment, the target electricity consumption regulation duration, and the power Rₚᵤₘₚ(t,D) of the ground source heat pump system as variables.

According to the embodiment of the present application, by drawing the three-dimensional regulation capability surface plot, the response power information of the PEDF devices, the smart lighting devices, the thermal storage electric boiler devices, and the ground source heat pump devices is visualized, and the performance of the devices under different regulation demands is displayed in a concise and intuitive manner, thereby providing data support for power grid regulation, which is conducive to the quantification of the regulation capabilities of different types of energy devices. In this manner, the electricity consumption strategy for the target electricity consumption regulation period can be obtained.

According to an embodiment of the present application, the step of aggregating the response power information of the energy devices of the same type according to the type information to generate the response power information of the energy subsystems includes: aggregating response power information of PEDF devices to generate response power information of PEDF subsystems; aggregating response power information of smart lighting devices to generate response power information of smart lighting subsystems; aggregating response power information of thermal storage electric boiler devices to generate response power information of thermal storage electric boiler subsystems; and aggregating response power information of ground source heat pump devices to generate response power information of ground source heat pump subsystems.

After the regulation capabilities of the devices are hierarchically and quantitatively evaluated, considering the mutual interactions among subsystems formed by energy devices of the same type, the regulation capabilities of subsystems formed by energy devices of the same type are evaluated by aggregating the response power information of energy devices of the same type.

The power of energy devices of the same type is summed to calculate the regulation capability of the subsystem formed by the energy devices.

The regulation capability of the PEDF subsystem is shown by formula (23) below.

$${P}_{storage , total} ( t , D ) = {\sum }_{i = 1}^{n} {f}_{i} ( {E}_{b} , {R}_{pv} , {R}_{b} , {R}_{V 2 G} , t , D ) \qquad ( 23 )$$

P_{storage,total}(t,D) denotes the regulation capability of the PEDF subsystem at moment t and is expressed in kW.

The regulation capability of the smart lighting subsystem is shown by formula (24) below.

$${P}_{schedule , total} ( t , D ) = {\sum }_{i = 1}^{n} {P}_{schedule\_adjusted , i} ( t , D ) \qquad ( 24 )$$

P_{schedule,total}(t,D) denotes the overall adjustment capability at moment t and is expressed in kW; and P_{schedule_adjusted,i}(t,D) denotes the power of the i-th smart lighting device adjusted according to the time schedule at moment t and is expressed in kW.

The regulation capability of the thermal storage electric boiler subsystem is shown by formula (25) below.

$${P}_{boiler , total} ( t , D ) = {\sum }_{i = 1}^{n} {R}_{boiler , i} ( t , D ) \qquad ( 25 )$$

P_{boiler,total}(t,D) denotes the regulation capability of the thermal storage electric boiler subsystem at moment t and is expressed in kW; and R_{boiler,i}(t,D) denotes the average power of the i-th thermal storage electric boiler device at moment t during the regulation duration D and is expressed in kW.

The regulation capability of the ground source heat pump subsystem is shown by formula (26) below.

$${P}_{pump , total} ( t , D ) = {\sum }_{i = 1}^{n} {R}_{pump , i} ( t , D ) \qquad ( 26 )$$

P_{pump,total}(t,D) denotes the regulation capability of the ground source heat pump subsystem at moment t and is expressed in kW; and R_{pump,i}(t,D) denotes the average power of the i-th ground source heat pump device at moment t during the target electricity consumption regulation duration D and is expressed in kW.

According to the embodiment of the present application, the response power information of the energy subsystems is generated by aggregating the response power information of devices of the same type, including the PEDF devices, the smart lighting devices, the thermal storage electric boiler devices, and the ground source heat pump devices. At the subsystem level, the regulation capabilities of the subsystems are quantitatively evaluated, the reliability and flexibility of the target region participating in dynamic regulation of the power grid are improved, the electricity consumption strategy for the target electricity consumption regulation period is obtained, and the regulation capabilities of heterogeneous energy devices and energy networks in the target region are accurately evaluated. In this manner, the safe operation of the energy devices in the target region during the electricity consumption regulation period of the power distribution network can be ensured, and a hierarchical evaluation index system for the integrated energy system in the target region can be constructed to satisfy minute-level dynamic regulation demands of the power grid.

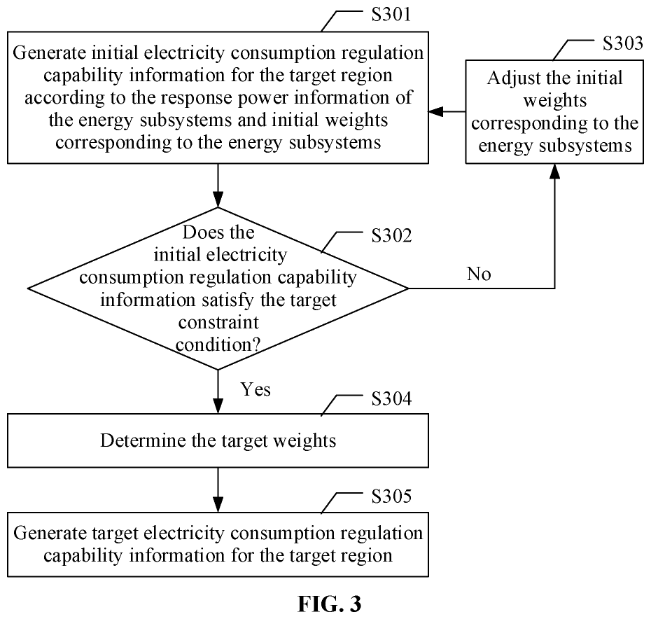

FIG. 3 is a flowchart of generating target electricity consumption regulation capability information for a target region according to an embodiment of the present application.

As shown in FIG. 3, a method 300 for generating the target electricity consumption regulation capability information for the target region in this embodiment includes operations S301 to S305.

In operation S301, initial electricity consumption regulation capability information for the target region is generated according to the response power information of the energy subsystems and initial weights corresponding to the energy subsystems.

In operation S302, whether the initial electricity consumption regulation capability information satisfies the target constraint condition is determined. If the initial electricity consumption regulation capability information satisfies the target constraint condition, operation S304 is performed. If the initial electricity consumption regulation capability information does not satisfy the target constraint condition, operation S303 is performed.

In operation S303, the initial weights corresponding to the energy subsystems are adjusted such that the initial electricity consumption regulation capability information satisfies the target constraint condition; and then operation S301 is performed.

In operation S304, the target weights are determined.

In response to the initial electricity consumption regulation capability information not satisfying the target constraint condition, the initial weights corresponding to the energy subsystems are adjusted until the target constraint condition is satisfied, thereby obtaining target weights.

In operation S305, target electricity consumption regulation capability information for the target region is generated according to the target weights and the response power information of the energy subsystems.

According to the embodiment of the present application, the initial weights corresponding to the energy subsystems represent the contribution degrees of the energy subsystems to the adjustable power of the energy devices in the target region.

Since the target region usually includes heterogeneous energy devices and multiple types of energy networks, the electricity demand of the target region is typically complex. Coordinating the electricity consumption regulation capability at the target-region level is of great importance for ensuring the supply stability of the external power grid and the efficient operation of the internal system. Determining the initial electricity consumption regulation capability information for the target region is intended to quantitatively evaluate the regulation capability of the entire target region at the target-region level.

The initial electricity consumption regulation capability information for the target region is generated according to the response power information of the energy subsystems and initial weights corresponding to the energy subsystems, which is shown by formula (27).

$$f ( t , D ) = α \cdot {P}_{storage , total} ( t , D ) + β \cdot {P}_{schedule , total} ( t , D ) + γ \cdot {P}_{boiler , total} ( t , D ) + δ \cdot {P}_{pump , total} ( t , D ) \qquad ( 27 )$$

α, β, γ, and δ denote weighting coefficients, which are used for adjusting the contribution degrees of the systems to the objective function.

The safety constraint condition plays a critical role in the evaluation of the electricity consumption regulation capability of the integrated energy system and is intended to ensure that the system can satisfy the energy demand while maintaining power grid stability. These constraint conditions cover key aspects such as the upper and lower limits of grid power and the upper and lower limits of grid voltage and frequency. By integrating these constraint conditions into the evaluation model, it can be ensured that the system does not exceed the carrying capacity of the power grid during actual operation, thereby effectively preventing risks of power shortages or overload. Such a comprehensive consideration facilitates optimal energy allocation and load balancing, enhances system flexibility and reliability, and further improves the overall safety and stability of the power grid.

When the target region participates in dynamic regulation of the power grid, variations in grid voltage and frequency are shown by formula (28) and formula (29) below.

$$V = {V}_{0} - {k}_{1} \cdot f ( t , D ) \qquad ( 28 )$$

$$f = {f}_{0} - {k}_{2} \cdot f ( t , D ) \qquad ( 29 )$$

V₀ denotes the reference voltage of the power grid, which is usually the voltage value under normal operating conditions and is expressed in V; f₀ denotes the reference frequency of the power grid, which is usually the frequency value under normal operating conditions and is expressed in Hz; k₁ denotes the sensitivity coefficient of voltage with respect to load variations; k₂ denotes the sensitivity coefficient of frequency with respect to load variations; V denotes the voltage of the power grid after the target region participates in regulation and is expressed in V; and f denotes the frequency of the power grid after the target region participates in regulation and is expressed in Hz.

The electricity consumption regulation capability of the target region is required to satisfy the following electricity consumption safety constraints as shown in formula (30), formula (31), and formula (32).

$${V}_{min} < V < {V}_{max} \qquad ( 30 )$$

$${f}_{min} < f < {f}_{max} \qquad ( 31 )$$

$${P}_{min} < {P}_{base} + f ( t , D ) < {P}_{max} \qquad ( 32 )$$

Vₘᵢₙ denotes the minimum allowable voltage value of the power grid and is expressed in V; Vₘₐₓ denotes the maximum allowable voltage value of the power grid and is expressed in V; fₘᵢₙ denotes the minimum allowable frequency value of the power grid and is expressed in Hz; fₘₐₓ denotes the maximum allowable frequency value of the power grid and is expressed in Hz; Pₘᵢₙ denotes the minimum allowable power limit of the power grid and is expressed in kW; Pₘₐₓ denotes the maximum allowable power limit of the power grid and is expressed in kW; and P_{base} denotes the load power of the target region under the reference condition, which usually refers to the average load under normal operating conditions and is expressed in kW.

Currently, China's energy transition toward green and low-carbon development is accelerating. The electricity demand of the target region is flexibly adjusted while the carbon constraint condition of the target region is considered, which is of significant importance for constructing a new type of power system and enhancing the “green” attribute of electricity. The carbon constraint condition of the target region affects the overall electricity consumption regulation capability of the target region at multiple levels. First, carbon constraint policies promote the optimization of the energy structure in the target region and the utilization of renewable energy, thereby enhancing the overall power regulation capability. Second, such constraints incentivize the target region to implement efficient energy management and demand-side response strategies to cope with power load fluctuations. In addition, the carbon emission constraint promotes the target region to strengthen flexibility and intelligence within the power system, ultimately improving the sustainable development capability of the target region. Therefore, the carbon constraint condition is not only a necessary measure for environmental protection but also a key driving factor for optimizing the power regulation capability of the target region.

Accordingly, in the present application, the hierarchical aggregation and evaluation of the integrated energy system in the target region are performed while the carbon constraint condition of the target region is considered. The carbon emission constraint of the target region is shown by formula (33).

$$K ( t ) = {\sum }_{i = 1}^{n} {C}_{i} {f}_{i} ( t , D ) \leq {K}_{max} \qquad ( 33 )$$

K(t) denotes the total carbon emissions at moment t and is expressed in kg CO₂; Cᵢ denotes the carbon emission factor of the i-th type of energy and is expressed in kg CO₂/kWh, indicating the carbon emissions generated per unit of energy consumed; fᵢ(t,D) denotes the adjustable power of the i-th type of load at moment t during the regulation duration D after weighting and is expressed in kW; and Kₘₐₓ denotes the carbon emission upper limit set for the target region and is expressed in kg CO₂.

According to the embodiment of the present application, when the initial electricity consumption regulation capability information does not satisfy the electricity consumption safety constraint and the carbon emission constraint condition, the initial weights corresponding to the energy subsystems are adjusted until all target constraint conditions are satisfied, thereby obtaining the target weights that satisfy the constraint conditions; and the target electricity consumption regulation capability information for the target region is generated according to the target weights and the response power information of the energy subsystems, thereby determining the electricity consumption regulation strategy for the target region.

For example: the initial weights α, β, γ, and δ are set to 0.1, 0.6, 0.4, and 0.5, respectively, the initial electricity consumption regulation capability information f(t,D) for the target region is generated according to the response power information of the energy subsystems, and the value of f(t,D) is substituted into the electricity consumption safety constraint and the carbon emission constraint for calculation. In the calculation results, the voltage V and frequency f of the power grid satisfy the threshold ranges, while the total carbon emissions K exceed the threshold Kₘₐₓ. In this case, the weight coefficients are adjusted accordingly. For example, weight values that satisfy the constraint conditions may be re-matched in a historical database, and the initial weights α, β, γ, and δ are adjusted to 0.2, 0.6, 0.3, and 0.7, respectively. In this case, all the calculation results satisfy the constraint conditions, resulting in the following target weights: α=0.2, β=0.6, γ=0.3, and δ=0.7. The target electricity consumption regulation capability information for the target region is generated according to the target weights and the response power information of the energy subsystems, thereby determining the electricity consumption regulation strategy for the target region, that is, adjusting the operating power of each energy device to the target power value.

According to the embodiment of the present application, by setting the weight coefficients, the contribution of each energy subsystem in the target region to the overall regulation capability of the system can be effectively quantified. By integrating the electricity consumption safety constraint and the carbon emission constraint into the evaluation model, if the electricity consumption safety constraint and the carbon emission condition are not satisfied, the weight coefficients are adjusted to satisfy the constraint conditions, thereby determining the electricity consumption regulation strategy. In this manner, the safe and stable operation of the system in practice can be ensured and the optimization of the energy structure in the target region can be promoted. Such a comprehensive and flexible regulation strategy facilitates optimal energy allocation and load balancing, enhances system flexibility and reliability, ensures the safe operation of the energy devices in the target region during the electricity consumption regulation period of the power distribution network, and achieves the rational construction of a hierarchical evaluation index system for the integrated energy system in the target region to satisfy minute-level dynamic regulation demands of the power grid.

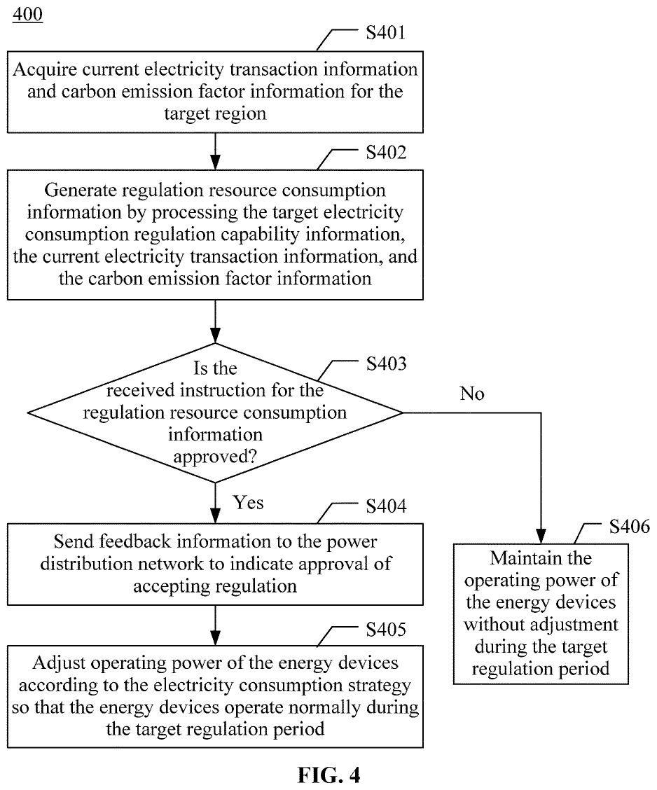

FIG. 4 is a flowchart of determining an electricity consumption strategy of energy devices based on regulation resource consumption information according to an embodiment of the present application.

As shown in FIG. 4, a method 400 for determining the electricity consumption strategy of the energy devices based on the regulation resource consumption information in this embodiment includes operations S401 to S406.

In operation S401, current electricity transaction information and carbon emission factor information for the target region are acquired.

In operation S402, regulation resource consumption information is generated by processing the target electricity consumption regulation capability information, the current electricity transaction information, and the carbon emission factor information.

In operation S403, whether to approve the received instruction for the regulation resource consumption information is determined. If the received instruction for the regulation resource consumption information is approved, operation S404 is performed. If the received instruction for the regulation resource consumption information is not approved, operation S406 is performed.

In operation S404, feedback information is sent to the power distribution network to indicate approval of accepting regulation.

In operation S405, operating power of the energy devices is adjusted according to the electricity consumption strategy so that the energy devices operate normally during the target regulation period.

In operation S406, the operating power of the energy devices is maintained without adjustment during the target regulation period.

In response to receiving an approval instruction for the regulation resource consumption information, feedback information is sent to the power distribution network to indicate approval of accepting regulation; and operating power of the energy devices is adjusted according to the electricity consumption strategy so that the energy devices operate normally during the target electricity consumption regulation period.

According to the embodiment of the present application, the electricity transaction information includes an electricity unit price, different moments correspond to different electricity prices, and the carbon emission factor information is a known input parameter with a fixed value.

The regulation resource consumption information represents a regulation cost required to perform instruction operations after receiving a power distribution network regulation instruction. The calculation method for the regulation resource consumption information is shown by formula (34), formula (35), and formula (36).

$${C}_{energy} = {\int }_{t}^{t + D} ( f ( t , D ) \cdot {C}_{price} ) dt \qquad ( 34 )$$

$${C}_{carbon} = {F}_{carbon} \cdot {\int }_{t}^{t + D} K ( t ) dt \cdot {C}_{price} \qquad ( 35 )$$

$${C}_{control} = {C}_{energy} + {C}_{carbon} \qquad ( 36 )$$

C_{energy} denotes the energy cost, which is calculated as the energy cost of charging and discharging in the target region during the regulation process; C_{price} denotes the electricity unit price, indicating the cost per kilowatt-hour; C_{carbon} denotes the carbon emission cost, which is calculated as the cost caused by carbon emissions generated in the target region during the regulation process; F_{carbon} denotes the carbon emission factor, indicating the amount of carbon emissions per unit of electricity; and C_{control} denotes the total regulation cost, indicating all costs required by the target region to support grid regulation.

The regulation resource consumption directly affects the economic incentives, energy selection, strategy flexibility, and carbon emission management of the target region participating in dynamic grid regulation. Reducing regulation costs and optimizing policies and technical support are of critical importance for enhancing the willingness of the target region to participate in grid regulation.

Therefore, during the actual operation and regulation of the system in the target region, the regulation resource consumption information is generated according to the preceding calculation formulas. According to the actual operating conditions of the target region, whether to agree to execute the instruction for the regulation resource consumption information is determined. When the instruction for the regulation resource consumption information satisfies an expected condition, feedback information is sent to the power distribution network to indicate approval of accepting regulation, and the operating power of the energy devices is adjusted according to the electricity consumption strategy. When the instruction for the regulation resource consumption information does not satisfy the expected condition, feedback information is sent to the power distribution network to indicate disapproval of accepting regulation, and the operating power of the energy devices is not adjusted during the target regulation period.

According to the embodiment of the present application, while the local grid safety constraint and the carbon constraint condition of the target region are considered, it is also necessary to consider the resource consumption resulting from the regulation which is made according to the operation states of the energy devices based on the regulation strategies. By introducing the resource consumption constraint as an economic evaluation factor into the hierarchical aggregation and evaluation method of electricity consumption regulation capabilities, the willingness of the target region to participate in grid regulation can be enhanced, while the flexibility and reliability of the method for determining an electricity consumption strategy based on electricity consumption regulation capabilities of multiple types of energy devices can be improved.

The process of the method for determining an electricity consumption strategy based on electricity consumption regulation capabilities of multiple types of energy devices is described below.

The regulation capabilities of different types of devices are evaluated according to the system structural parameters and historical load information of the energy devices in the target region. Electricity consumption regulation capability evaluation is performed on the subsystem formed by a single type of device, thereby achieving block-based quantitative evaluation of multiple types of energy devices in the target region. The subsystems are coordinated and aggregated. In conjunction with the local grid safety constraint condition and the carbon constraint condition of the target region, the electricity consumption regulation capability of the integrated energy system in the target region is evaluated. The resource consumption of regulation strategies with different regulation capacities is evaluated to provide a reference for the user in the target region to select a regulation strategy.

The evaluation model constructed in the preceding method comprehensively considers factors such as renewable energy scheduling, grid carbon emissions, load regulation capabilities, and energy efficiency improvement. By evaluating the electricity consumption regulation capabilities of the target region in the preceding method, the overall regulation capability of the integrated energy system in the target region can be measured, which enables flexible regulation of electricity consumption capabilities to support external grid dynamics while reducing carbon emissions and ensuring local grid safety.

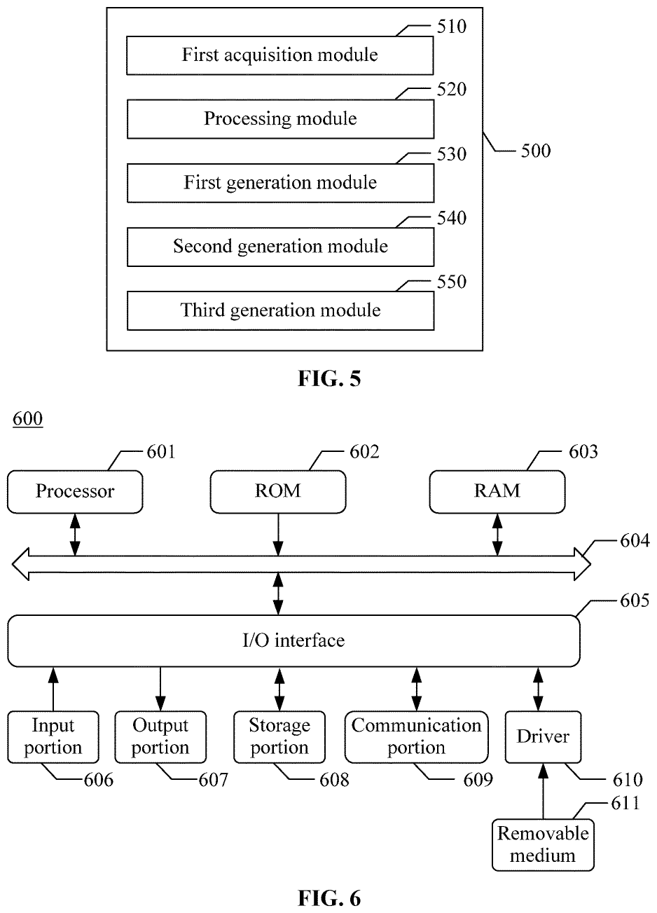

Based on the method for determining an electricity consumption strategy based on electricity consumption regulation capabilities of multiple types of energy devices, the present application further provides an apparatus for determining an electricity consumption strategy based on electricity consumption regulation capabilities of multiple types of energy devices. The apparatus is described below in conjunction with FIG. 5.

FIG. 5 is a block diagram of an apparatus for determining an electricity consumption strategy based on electricity consumption regulation capabilities of multiple types of energy devices according to an embodiment of the present application.

As shown in FIG. 5, an apparatus 500 for determining an electricity consumption strategy based on electricity consumption regulation capabilities of multiple types of energy devices in this embodiment includes a first acquisition module 510, a processing module 520, a first generation module 530, a second generation module 540, and a third generation module 550.

The first acquisition module 510 is configured to, in response to receiving a power distribution regulation instruction from a power distribution network, acquire type information of multiple energy devices within a target region, a target electricity consumption regulation period, and historical load information of the energy devices corresponding to the target electricity consumption regulation period. In an embodiment, the first acquisition module 510 may be configured to perform the operation S210 described above. The details are not repeated here.

The processing module 520 is configured to separately process the historical load information of the energy devices and the target electricity consumption regulation period according to evaluation strategies for the electricity consumption regulation capabilities corresponding to the type information to generate response power information of the energy devices. In an embodiment, the processing module 520 may be configured to perform the operation S220 described above. The details are not repeated here.

The first generation module 530 is configured to aggregate the response power information of the energy devices of the same type according to the type information to generate response power information of energy subsystems. In an embodiment, the first generation module 530 may be configured to perform the operation S230 described above. The details are not repeated here.

The second generation module 540 is configured to generate initial electricity consumption regulation capability information for the target region according to the response power information of the energy subsystems and initial weights corresponding to the energy subsystems. In an embodiment, the second generation module 540 may be configured to perform the operation S240 described above. The details are not repeated here.

The third generation module 550 is configured to, in response to the initial electricity consumption regulation capability information satisfying a target constraint condition, generate the electricity consumption strategy for the target electricity consumption regulation period according to the response power information of the energy devices, where the target constraint condition includes an electricity consumption safety constraint and a carbon emission constraint for the target region. In an embodiment, the third generation module 550 may be configured to perform the operation S250 described above. The details are not repeated here.

According to an embodiment of the present application, the processing module includes a first determination submodule, a first generation submodule, a second generation submodule, a third generation submodule, and a fourth generation submodule.

The first determination submodule is configured to determine a target electricity consumption regulation duration according to the target electricity consumption regulation period. The first generation submodule is configured to generate response power information of PEDF devices by processing the target electricity consumption regulation duration and historical load information of the PEDF devices based on an evaluation strategy corresponding to the PEDF devices. The second generation submodule is configured to generate response power information of smart lighting devices by processing the target electricity consumption regulation duration and historical load information of the lighting devices based on an evaluation strategy corresponding to the smart lighting devices. The third generation submodule is configured to generate response power information of thermal storage electric boiler devices by processing the target electricity consumption regulation duration and historical load information of the thermal storage electric boiler devices based on an evaluation strategy corresponding to the thermal storage electric boiler devices. The fourth generation submodule is configured to generate response power information of ground source heat pump devices by processing the target electricity consumption regulation duration and historical load information of the ground source heat pump devices based on an evaluation strategy corresponding to the ground source heat pump devices.

According to an embodiment of the present application, the preceding apparatus further includes a visual display module configured to separately display the response power information of the PEDF devices, the response power information of the smart lighting devices, the response power information of the thermal storage electric boiler devices, and the response power information of the ground source heat pump devices through a visual interface.

According to an embodiment of the present application, the first generation module includes a first subsystem generation submodule, a second subsystem generation submodule, a third subsystem generation submodule, and a fourth subsystem generation submodule.

The first subsystem generation submodule is configured to aggregate response power information of PEDF devices to generate response power information of PEDF subsystems. The second subsystem generation submodule is configured to aggregate response power information of smart lighting devices to generate response power information of smart lighting subsystems.

The third subsystem generation submodule is configured to aggregate response power information of thermal storage electric boiler devices to generate response power information of thermal storage electric boiler subsystems. The fourth subsystem generation submodule is configured to aggregate response power information of ground source heat pump devices to generate response power information of ground source heat pump subsystems.

According to an embodiment of the present application, the preceding apparatus further includes a target weight generation submodule and a target electricity consumption regulation capability information generation submodule.

The target weight generation submodule is configured to, in response to the initial electricity consumption regulation capability information not satisfying the target constraint condition, adjust the initial weights corresponding to the energy subsystems until the target constraint condition is satisfied, thereby obtaining target weights. The target electricity consumption regulation capability information generation submodule is configured to generate target electricity consumption regulation capability information for the target region according to the target weights and the response power information of the energy subsystems.

According to an embodiment of the present application, the preceding apparatus further includes a first acquisition submodule and a regulation resource consumption information generation submodule.

The first acquisition submodule is configured to acquire current electricity transaction information and carbon emission factor information for the target region. The regulation resource consumption information generation submodule is configured to generate regulation resource consumption information by processing the target electricity consumption regulation capability information, the current electricity transaction information, and the carbon emission factor information.

According to an embodiment of the present application, the preceding apparatus further includes a transmission submodule and an adjustment submodule.

The transmission submodule is configured to, in response to receiving an approval instruction for the regulation resource consumption information, send feedback information to the power distribution network to indicate approval of accepting regulation. The adjustment submodule is configured to adjust operating power of the energy devices according to the electricity consumption strategy so that the energy devices operate normally during the target regulation period.

FIG. 6 is a block diagram of an electronic device for a method for determining an electricity consumption strategy based on electricity consumption regulation capabilities of multiple types of energy devices according to an embodiment of the present application.

As shown in FIG. 6, an electronic device 600 according to the embodiments of the present application includes a processor 601. The processor 601 can perform various appropriate actions and processing according to a program stored in a read-only memory (ROM) 602 or a program loaded into a random-access memory (RAM) 603 from a storage portion 608. For example, the processor 601 may include a general-purpose microprocessor (such as a central processing unit (CPU)), an instruction set processor and/or an associated chipset and/or a dedicated microprocessor (for example, an application-specific integrated circuit (ASIC)), and the like. The processor 601 may further include an on-board memory configured for caching. The processor 601 may include a single processing unit or multiple processing units configured to perform different actions of the method processes according to the embodiments of the present application.

Various programs and data necessary for the operation of the electronic device 600 are stored in the RAM 603. The processor 601, the ROM 602, and the RAM 603 are connected to each other through a bus 604. The processor 601 performs multiple operations of the method processes according to the embodiments of the present application by executing programs in the ROM 602 and/or the RAM 603. The programs may also be stored in one or more memories other than the ROM 602 and the RAM 603. The processor 601 may also perform multiple operations of the method processes according to the embodiments of the present application by executing programs stored in the one or more memories.

According to the embodiments of the present application, the electronic device 600 may further include an input/output (I/O) interface 605, and the I/O interface 605 is also connected to the bus 604. The electronic device 600 may further include one or more of the following components connected to the I/O interface 605: an input portion 606 including a keyboard, a mouse, or the like; an output portion 607 including, for example, a cathode ray tube (CRT), a liquid-crystal display (LCD), a speaker, or the like; the storage portion 608 including a hard disk or the like; and a communication portion 609 including a network interface card such as a local area network (LAN) card or a modem. The communication portion 609 performs communication processing via a network such as the Internet. A driver 610 is also connected to the I/O interface 605 as required. A removable medium 611, such as a magnetic disk, an optical disc, a magneto-optical disk, or a semiconductor memory, is installed on the driver 610 as required, so that computer programs read therefrom can be installed into the storage portion 608 as required.

The present application further provides a computer-readable storage medium, which may be included in the device/apparatus/system described in the preceding embodiments or may exist independently without being installed into the device/apparatus/system. The preceding computer-readable storage medium carries one or more programs, and when the one or more programs are executed, the method according to the embodiments of the present application is performed.

According to the embodiments of the present application, the computer-readable storage medium may be a non-volatile computer-readable storage medium, which may include, for example, a portable computer disk, a hard disk, a RAM, a ROM, an electrically erasable programmable read-only memory (EPROM), a flash memory, a portable compact disc read-only memory (CD-ROM), an optical storage device, a magnetic storage device, or any appropriate combination thereof. In the present application, the computer-readable storage medium may be any tangible medium including or storing a program. The program may be used by or used in conjunction with an instruction execution system, apparatus, or device. For example, according to the embodiments of the present application, the computer-readable storage medium may include the ROM 602, and/or the RAM 603, and/or one or more memories other than the ROM 602 and the RAM 603. The storage medium may be a non-transitory storage medium.

The embodiments of the present application further provide a computer program product, which includes a computer program, and the computer program includes program codes for performing the method shown in the flowchart. When the computer program product is executed on a computer system, the program codes cause the computer system to perform the method for determining an electricity consumption strategy based on electricity consumption regulation capabilities of multiple types of energy devices according to the embodiments of the present application.

When the computer program is executed by the processor 601, the preceding functions defined in the system/apparatus of the embodiments of the present application are implemented. According to the embodiments of the present application, the system, apparatus, modules, units, and the like described above may be implemented through computer program modules.

In an embodiment, the computer program may be embodied on a tangible storage medium, such as an optical storage device or a magnetic storage device. In another embodiment, the computer program may also be transmitted or distributed in the form of a signal over a network medium, and downloaded and installed via the communication portion 609, and/or installed from the removable medium 611. The program codes included in the computer program may be transmitted via any appropriate network medium, including the wireless network, the wired network, or any appropriate combination thereof.

In such an embodiment, the computer program may be downloaded and installed from a network via the communication portion 609, and/or installed from the removable medium 611. When the computer program is executed by the processor 601, the preceding functions defined in the system of the embodiments of the present application are implemented. According to the embodiments of the present application, the system, device, apparatus, modules, units, and the like described above may be implemented through computer program modules.

According to the embodiments of the present application, the program codes for executing the computer programs provided by the embodiments of the present application may be written in any combination of one or more programming languages, and these computer programs may be implemented using high-level procedural and/or object-oriented programming languages, and/or assembly/machine languages. The programming languages include, for example, Java, C++, Python, “C”, or similar programming languages. The program codes may be executed entirely on a user computing device, partially on a user computing device, partially on a remote computing device, or entirely on a remote computing device or server. In the scenario involving the remote computing device, the remote computing device may be connected to the user computing device through any type of network, including a LAN or a wide area network (WAN), or may be connected to an external computing device (for example, via the Internet provided by an Internet service provider).

The flowcharts and block diagrams in the drawings illustrate possible architectures, functions, and operations of the system, method, and computer program product according to the embodiments of the present application. In this regard, each block in the flowcharts or block diagrams may represent a module, a program segment, or part of codes. The module, program segment, or part of codes contains one or more executable instructions for implementing specified logical functions. It is to be noted that in some alternative implementations, the functions marked in the blocks may occur in an order different from that marked in the drawings. For example, two successive blocks may, in practice, be executed substantially in parallel or executed in a reverse order, which depends on the functions involved. It is also to be noted that each block in the block diagrams or flowcharts and a combination of blocks in the block diagrams or flowcharts may be implemented by a specific-purpose hardware-based system which implements specified functions or operations or may be implemented by a combination of specific-purpose hardware and computer instructions.

The features described in the embodiments and/or claims of the present application may be combined or integrated in multiple manners, even if such combinations or integrations are not explicitly described in the present application. The features described in the embodiments and/or claims of the present application may be combined and/or integrated in multiple manners. All such combinations and/or integrations fall within the scope of the present application.

What is claimed is:

1. A method for determining an electricity consumption strategy based on electricity consumption regulation capabilities of multiple types of energy devices, comprising:
in response to receiving a power distribution regulation instruction from a power distribution network, acquiring type information of a plurality of energy devices within a target region, a target electricity consumption regulation period, and historical load information of the plurality of energy devices corresponding to the target electricity consumption regulation period, wherein the power distribution regulation instruction comprises a regulation moment and a regulation duration corresponding to execution of an electricity consumption regulation operation;
separately processing the historical load information of the plurality of energy devices and the target electricity consumption regulation period according to evaluation strategies for the electricity consumption regulation capabilities corresponding to the type information to generate response power information of the plurality of energy devices;
aggregating the response power information of the plurality of energy devices of a same type according to the type information to generate response power information of a plurality of energy subsystems;
generating initial electricity consumption regulation capability information for the target region according to the response power information of the plurality of energy subsystems and initial weights corresponding to the plurality of energy subsystems; and
in response to the initial electricity consumption regulation capability information satisfying a target constraint condition, generating the electricity consumption strategy for the target electricity consumption regulation period according to the response power information of the plurality of energy devices to satisfy minute-level dynamic regulation demands of the power distribution network during the target electricity consumption regulation period and ensure an safe operation of the plurality of energy devices within the target region during the target electricity consumption regulation period, wherein the target constraint condition comprises an electricity consumption safety constraint and a carbon emission constraint for the target region;
wherein separately processing the historical load information of the plurality of energy devices and the target electricity consumption regulation period according to the evaluation strategies for the electricity consumption regulation capabilities corresponding to the type information to generate the response power information of the plurality of energy devices comprises:
determining a target electricity consumption regulation duration according to the target electricity consumption regulation period;
generating response power information of a plurality of photovoltaics, energy storage, direct current, and flexibility (PEDF) devices by processing the target electricity consumption regulation duration and historical load information of the plurality of PEDF devices based on an evaluation strategy corresponding to the PEDF devices, wherein the response power information of the PEDF devices comprises:
$${P}_{pv} ( t ) = min ( {P}_{pv , max} , G \cdot A \cdot η ) ;$$
$${P}_{pv} ( t , D ) = \frac{1}{D} {\int }_{t}^{t + D} {P}_{pv} ( t ) dt ;$$
wherein Pₚᵥ(t) denotes a photovoltaic power output and is expressed in kW; G denotes a solar radiation intensity and is expressed in kW/m²; A denotes an effective area of a photovoltaic panel and is expressed in m²; η denotes a conversion efficiency of the photovoltaic panel; P_{pv,max} denotes a maximum photovoltaic power output and is expressed in kW; D denotes the target electricity consumption regulation duration and is expressed in s; t denotes a target electricity consumption regulation moment; and Rₚᵥ(t,D) denotes an average photovoltaic power output during the target electricity consumption regulation duration D and is expressed in kW;
$${P}_{b , c} ( t ) = min ( {P}_{b , c , max} , {P}_{pv} ( t ) - {P}_{load} ( t ) ) ;$$
$${P}_{b , d} ( t ) = min ( {P}_{b , d , max} , {P}_{load} ( t ) - {P}_{pv} ( t ) ) ;$$
$${R}_{b} ( t , D ) = \frac{1}{D} {\int }_{t}^{t + D} ( {P}_{b , c} ( t ) - {P}_{b , d} ( t ) ) dt ;$$
wherein P_{b,c}(t) denotes a charge power of an energy storage system and is expressed in kW; P_{b,d}(t) denotes a discharge power of the energy storage system and is expressed in kW; P_{b,c,max} denotes a maximum charge power of the energy storage system and is expressed in kW; P_{b,d,max} denotes a maximum discharge power of the energy storage system and is expressed in kW; P_{load}(t) denotes a load power at a moment t and is expressed in kW; and R_{b}(t,D) denotes an average power of the energy storage system during the target electricity consumption regulation duration D and is expressed in kW;
$${P}_{c} ( t ) = max ( 0 , min ( {P}_{c , max} , {P}_{v 2 g , charge} ( t ) ) ) ;$$
$${P}_{d} ( t ) = max ( 0 , min ( {P}_{d , max} , {P}_{v 2 g , discharge} ( t ) ) ) ;$$
$${R}_{V 2 G} ( t , D ) = \frac{1}{D} {\int }_{t}^{t + D} ( {P}_{d} ( t ) - {P}_{c} ( t ) ) dt ;$$
wherein P_{c}(t) denotes a charge power of a charging pile to an electric vehicle and is expressed in kW; P_{d}(t) denotes a discharge power of the electric vehicle to the power grid and is expressed in kW; P_{c,max} denotes a maximum charge power of the charging pile to the electric vehicle and is expressed in kW; P_{d,max} denotes a maximum discharge power of the electric vehicle to the power grid and is expressed in kW; P_{v2g,charge}(t) denotes a allowed charge power of the vehicle at the moment t and is expressed in kW; P_{v2g,discharge}(t) denotes a allowed discharge power of the vehicle at the moment t and is expressed in kW; and R_{V2G}(t,D) denotes an average power of the charging pile during the target electricity consumption regulation duration D and is expressed in kW;
wherein the overall electricity consumption regulation power of the PEDF device is:
$$f ( {E}_{b} , {R}_{pv} , {R}_{b} , {T}_{V 2 G} , t , D ) = min ( {R}_{pv} ( t , D ) + {R}_{b} ( t , D ) + {R}_{V 2 G} ( t , D ) ) ;$$
generating response power information of a plurality of smart lighting devices by processing the target electricity consumption regulation duration and historical load information of the plurality of smart lighting devices based on an evaluation strategy corresponding to the smart lighting devices, wherein the response power information of the plurality of smart lighting devices comprises:
$${P}_{light} ( t ) = min ( {P}_{light , max} , {D}_{light} ( t ) ( \frac{{L}_{current} ( t )}{{L}_{max}} \cdot {F}_{demand} ( t ) \cdot {F}_{schedule} ( t ) ) ;$$
$${R}_{light} ( t , D ) = \frac{1}{D} {\int }_{t}^{t + D} {P}_{light} ( t ) dt ;$$
wherein P_{light}(t) denotes a lighting power at the moment t and is expressed in kW; P_{light,max} denotes a maximum power of a light and is expressed in kW; D_{light}(t) denotes a lighting demand at the moment t and is expressed in kW; L_{current}(t) denotes an actual luminous intensity at the moment t and is expressed in lm; Lₘₐₓ denotes a maximum luminous intensity of the light and is expressed in lm; F_{demand}(t) denotes a demand response coefficient at the moment t, indicating a degree of a grid load response; F_{schedule}(t) denotes a time scheduling factor at the moment t; and R_{light}(t,D) denotes an average power of a smart lighting device during the target electricity consumption regulation duration D and is expressed in kW;
wherein when the target region participates in grid regulation, a demand response power is adjusted according to the following formula:
$${P}_{demand\_response} ( t , D ) = {P}_{current} ( t ) - {R}_{light} ( t , D ) ;$$
wherein P_{demand_response}(t,D) denotes a demand response power at the moment t and is expressed in kW; and P_{current}(t) denotes an actual lighting power at the moment t and is expressed in kW;
wherein when the target region participates in grid regulation, a time-scheduled power of the smart lighting system is shown by the following formula:
$${P}_{schedule\_adjusted} ( t , D ) = {P}_{demand\_response} ( t , D ) - {F}_{schedule} ( t ) ;$$
wherein P_{schedule_adjusted}(t,D) denotes a power adjusted according to the time schedule at the moment t and is expressed in kW;
generating response power information of a plurality of thermal storage electric boiler devices by processing the target electricity consumption regulation duration and historical load information of the plurality of thermal storage electric boiler devices based on an evaluation strategy corresponding to the thermal storage electric boiler devices;
$${P}_{boiler} ( t ) = min ( {P}_{boiler , max} , {P}_{demand} ( t ) ) ;$$
$${P}_{demand} ( t ) = max ( 0 , \frac{( {T}_{target} - {T}_{env} ( t ) \cdot {C}_{load}}{{η}_{boiler}} - {E}_{boiler} ( t ) \cdot \frac{1}{{η}_{boiler}} ) ;$$
$${R}_{boiler} ( t , D ) = \frac{1}{D} {\int }_{t}^{t + D} {P}_{boiler} ( t ) dt ;$$
wherein P_{boiler}(t) denotes a power of an electric boiler at the moment t and is expressed in kW; P_{boiler,max} denotes a maximum power output of the electric boiler and is expressed in kW; P_{demand}(t) denotes a heat load demand of the electric boiler and is expressed in kW; T_{target} denotes a desired indoor temperature and is expressed in degrees Celsius; Tₑₙᵥ(t) denotes an environmental temperature at the moment t and is expressed in degrees Celsius; C_{load} denotes a load heat capacity and is expressed in kWh/degree; η_{boiler} denotes a thermal efficiency of the electric boiler; E_{boiler}(t) denotes stored heat at the moment t and is expressed in kWh; and R_{boiler}(t,D) denotes an average power of the thermal storage electric boiler devices during the target electricity consumption regulation duration D and is expressed in kW; and
generating response power information of a plurality of ground source heat pump devices by processing the target electricity consumption regulation duration and historical load information of the plurality of ground source heat pump devices based on an evaluation strategy corresponding to the ground source heat pump devices;
$${Q}_{demand} ( t ) = {C}_{load} \cdot Δ T ( t )$$
$${P}_{pump} ( t ) = min ( {P}_{pump , max} , \frac{{Q}_{demand} ( t )}{COP ( {T}_{env} ( t ) , {T}_{out} ( t ) )} ) ;$$
$$COP ( {T}_{env} ( t ) , {T}_{out} ( t ) ) = \frac{{T}_{out} ( t )}{{T}_{out} ( t ) - {T}_{env} ( t )} ;$$
$${R}_{pump} ( t , D ) = \frac{1}{D} {\int }_{t}^{t + D} {P}_{pump} ( t ) dt ;$$
wherein Q_{demand}(t) denotes a heat load demand at the moment t and is expressed in kW; C_{load} denotes a load heat capacity and is expressed in kWh/degree; ΔT(t) denotes a difference between a target temperature and an environmental temperature at the moment t and is expressed in degrees Celsius; COP(Tₑₙᵥ(t), Tₒᵤₜ(t)) denotes a performance coefficient of the ground source heat pump devices; Pₚᵤₘₚ(t) denotes a power of the ground source heat pump devices at the moment t and is expressed in kW; P_{pump,max} denotes a maximum power of the ground source heat pump devices and is expressed in kW; Rₚᵤₘₚ(t,D) denotes an average power of the ground source heat pump devices during the target electricity consumption regulation duration D and is expressed in kW; Tₑₙᵥ(t) denotes an environmental temperature at the moment t and is expressed in degrees Celsius; and Tₒᵤₜ(t) denotes an output temperature of the ground source heat pump devices at the moment t and is expressed in degrees Celsius.

2. The method of claim 1, further comprising:
separately displaying the response power information of the plurality of PEDF devices, the response power information of the plurality of smart lighting devices, the response power information of the plurality of thermal storage electric boiler devices, and the response power information of the plurality of ground source heat pump devices through a visual interface.

3. The method of claim 1, wherein aggregating the response power information of the plurality of energy devices of the same type according to the type information to generate the response power information of the plurality of energy subsystems comprises:
aggregating response power information of a plurality of PEDF devices to generate response power information of PEDF subsystems;
aggregating response power information of a plurality of smart lighting devices to generate response power information of smart lighting subsystems;
aggregating response power information of a plurality of thermal storage electric boiler devices to generate response power information of thermal storage electric boiler subsystems; and
aggregating response power information of a plurality of ground source heat pump devices to generate response power information of ground source heat pump subsystems.

4. The method of claim 1, further comprising:
in response to the initial electricity consumption regulation capability information not satisfying the target constraint condition, adjusting the initial weights corresponding to the plurality of energy subsystems until the target constraint condition is satisfied, thereby obtaining target weights; and
generating target electricity consumption regulation capability information for the target region according to the target weights and the response power information of the plurality of energy subsystems.

5. The method of claim 4, further comprising:
acquiring current electricity transaction information and carbon emission factor information for the target region; and
generating regulation resource consumption information by processing the target electricity consumption regulation capability information, the current electricity transaction information, and the carbon emission factor information.

6. The method of claim 5, further comprising:
in response to receiving an approval instruction for the regulation resource consumption information, sending feedback information to the power distribution network to indicate approval of accepting regulation; and
adjusting operating power of the plurality of energy devices according to the electricity consumption strategy so that the plurality of energy devices operate normally during the target electricity consumption regulation period.

7. An electronic device, comprising:
one or more processors; and
a memory configured to store one or more computer programs;
wherein the one or more processors execute the one or more computer programs to perform the following steps:
in response to receiving a power distribution regulation instruction from a power distribution network, acquiring type information of a plurality of energy devices within a target region, a target electricity consumption regulation period, and historical load information of the plurality of energy devices corresponding to the target electricity consumption regulation period, wherein the power distribution regulation instruction comprises a regulation moment and a regulation duration corresponding to execution of an electricity consumption regulation operation;
separately processing the historical load information of the plurality of energy devices and the target electricity consumption regulation period according to evaluation strategies for the electricity consumption regulation capabilities corresponding to the type information to generate response power information of the plurality of energy devices;
aggregating the response power information of the plurality of energy devices of a same type according to the type information to generate response power information of a plurality of energy subsystems;
generating initial electricity consumption regulation capability information for the target region according to the response power information of the plurality of energy subsystems and initial weights corresponding to the plurality of energy subsystems; and
in response to the initial electricity consumption regulation capability information satisfying a target constraint condition, generating an electricity consumption strategy for the target electricity consumption regulation period according to the response power information of the plurality of energy devices to satisfy minute-level dynamic regulation demands of the power distribution network during the target electricity consumption regulation period and ensure an safe operation of the plurality of energy devices within the target region during the target electricity consumption regulation period, wherein the target constraint condition comprises an electricity consumption safety constraint and a carbon emission constraint for the target region;
wherein separately processing the historical load information of the plurality of energy devices and the target electricity consumption regulation period according to the evaluation strategies for the electricity consumption regulation capabilities corresponding to the type information to generate the response power information of the plurality of energy devices comprises:
determining a target electricity consumption regulation duration according to the target electricity consumption regulation period;
generating response power information of a plurality of photovoltaics, energy storage, direct current, and flexibility (PEDF) devices by processing the target electricity consumption regulation duration and historical load information of the plurality of PEDF devices based on an evaluation strategy corresponding to the PEDF devices, wherein the response power information of the PEDF devices comprises:
$${P}_{pv} ( t ) = min ( {P}_{pv , max} , G \cdot A \cdot η ) ;$$
$${P}_{pv} ( t , D ) = \frac{1}{D} {\int }_{t}^{t + D} {P}_{pv} ( t ) dt ;$$
wherein Pₚᵥ(t) denotes a photovoltaic power output and is expressed in kW; G denotes a solar radiation intensity and is expressed in kW/m²; A denotes an effective area of a photovoltaic panel and is expressed in m²; η denotes a conversion efficiency of the photovoltaic panel; P_{pv,max} denotes a maximum photovoltaic power output and is expressed in kW; D denotes the target electricity consumption regulation duration and is expressed in s; t denotes a target electricity consumption regulation moment; and Rₚᵥ(t,D) denotes an average photovoltaic power output during the target electricity consumption regulation duration D and is expressed in kW;
$${P}_{b , c} ( t ) = min ( {P}_{b , c , max} , {P}_{pv} ( t ) - {P}_{load} ( t ) ) ;$$
$${P}_{b , d} ( t ) = min ( {P}_{b , d , max} , {P}_{load} ( t ) - {P}_{pv} ( t ) ) ;$$
$${R}_{b} ( t , D ) = \frac{1}{D} {\int }_{t}^{t + D} ( {P}_{b , c} ( t ) - {P}_{b , d} ( t ) ) dt ;$$
wherein P_{b,c}(t) denotes a charge power of an energy storage system and is expressed in kW; P_{b,d}(t) denotes a discharge power of the energy storage system and is expressed in kW; P_{b,c,max} denotes a maximum charge power of the energy storage system and is expressed in kW; P_{b,d,max} denotes a maximum discharge power of the energy storage system and is expressed in kW; P_{load}(t) denotes a load power at a moment t and is expressed in kW; and R_{b}(t,D) denotes an average power of the energy storage system during the target electricity consumption regulation duration D and is expressed in kW;
$${P}_{c} ( t ) = max ( 0 , min ( {P}_{c , max} , {P}_{v 2 g , charge} ( t ) ) ) ;$$
$${P}_{d} ( t ) = max ( 0 , min ( {P}_{d , max} , {P}_{v 2 g , discharge} ( t ) ) ) ;$$
$${R}_{V 2 G} ( t , D ) = \frac{1}{D} {\int }_{t}^{t + D} ( {P}_{d} ( t ) - {P}_{c} ( t ) ) dt ;$$
wherein P_{c}(t) denotes a charge power of a charging pile to an electric vehicle and is expressed in kW; P_{d}(t) denotes a discharge power of the electric vehicle to the power grid and is expressed in kW; P_{c,max} denotes a maximum charge power of the charging pile to the electric vehicle and is expressed in kW; P_{d,max} denotes a maximum discharge power of the electric vehicle to the power grid and is expressed in kW; P_{v2g,charge}(t) denotes a allowed charge power of the vehicle at the moment t and is expressed in kW; P_{v2g,discharge}(t) denotes a allowed discharge power of the vehicle at the moment t and is expressed in kW; and R_{V2G}(t,D) denotes an average power of the charging pile during the target electricity consumption regulation duration D and is expressed in kW; wherein the overall electricity consumption regulation power of the PEDF device is:
$$f ( {E}_{b} , {R}_{pv} , {R}_{b} , {R}_{V 2 G} , t , D ) = min ( {R}_{pv} ( t , D ) + {R}_{b} ( t , D ) + {R}_{V 2 G} ( t , D ) ) ;$$
generating response power information of a plurality of smart lighting devices by processing the target electricity consumption regulation duration and historical load information of the plurality of smart lighting devices based on an evaluation strategy corresponding to the smart lighting devices, wherein the response power information of the plurality of smart lighting devices comprises:
$${P}_{light} ( t ) = min ( {P}_{light , max} , {D}_{light} ( t ) ( \frac{{L}_{current} ( t )}{{L}_{max}} \cdot {F}_{demand} ( t ) \cdot {F}_{schedule} ( t ) ) ;$$
$${R}_{light} ( t , D ) = \frac{1}{D} {\int }_{t}^{t + D} {P}_{light} ( t ) dt ;$$
wherein P_{light}(t) denotes a lighting power at the moment t and is expressed in kW; P_{light,max} denotes a maximum power of a light and is expressed in kW; D_{light}(t) denotes a lighting demand at the moment t and is expressed in kW; L_{current}(t) denotes an actual luminous intensity at the moment t and is expressed in lm; Lₘₐₓ denotes a maximum luminous intensity of the light and is expressed in lm; F_{demand}(t) denotes a demand response coefficient at the moment t, indicating a degree of a grid load response; F_{schedule}(t) denotes a time scheduling factor at the moment t; and R_{light}(t,D) denotes an average power of a smart lighting device during the target electricity consumption regulation duration D and is expressed in kW;
wherein when the target region participates in grid regulation, a demand response power is adjusted according to the following formula:
$${P}_{demand\_response} ( t , D ) = {P}_{current} ( t ) - {R}_{light} ( t , D ) ;$$
wherein P_{demand_response}(t,D) denotes a demand response power at the moment t and is expressed in kW; and P_{current}(t) denotes an actual lighting power at the moment t and is expressed in kW;
wherein when the target region participates in grid regulation, a time-scheduled power of the smart lighting system is shown by the following formula:
$${P}_{schedule\_adjusted} ( t , D ) = {P}_{demand\_response} ( t , D ) \cdot {F}_{schedule} ( t ) ;$$
wherein P_{schedule_adjusted}(t,D) denotes a power adjusted according to the time schedule at the moment t and is expressed in kW;
generating response power information of a plurality of thermal storage electric boiler devices by processing the target electricity consumption regulation duration and historical load information of the plurality of thermal storage electric boiler devices based on an evaluation strategy corresponding to the thermal storage electric boiler devices;
$${P}_{boiler} ( t ) = min ( {P}_{boiler , max} , {P}_{demand} ( t ) ) ;$$
$${P}_{demand} ( t ) = max ( 0 , \frac{{T}_{target} - {T}_{env} ( t ) \cdot {C}_{load}}{{η}_{boiler}} - {E}_{boiler} ( t ) \cdot \frac{1}{{η}_{boiler}} ) ;$$
$${R}_{boiler} ( t , D ) = \frac{1}{D} {\int }_{t}^{t + D} {P}_{boiler} ( t ) dt ;$$
wherein P_{boiler}(t) denotes a power of an electric boiler at the moment t and is expressed in kW; P_{boiler}, max denotes a maximum power output of the electric boiler and is expressed in kW; P_{demand}(t) denotes a heat load demand of the electric boiler and is expressed in kW; T_{target} denotes a desired indoor temperature and is expressed in degrees Celsius; Tₑₙᵥ(t) denotes an environmental temperature at the moment t and is expressed in degrees Celsius; C_{load} denotes a load heat capacity and is expressed in kWh/degree; η_{boiler} denotes a thermal efficiency of the electric boiler; E_{boiler}(t) denotes stored heat at the moment t and is expressed in kWh; and R_{boiler}(t,D) denotes an average power of the thermal storage electric boiler devices during the target electricity consumption regulation duration D and is expressed in kW; and
generating response power information of a plurality of ground source heat pump devices by processing the target electricity consumption regulation duration and historical load information of the plurality of ground source heat pump devices based on an evaluation strategy corresponding to the ground source heat pump devices;
$${Q}_{demand} ( t ) = {C}_{load} \cdot Δ T ( t ) ;$$
$${P}_{pump} ( t ) = min ( {P}_{pump , max} , \frac{{Q}_{demand} ( t )}{COP ( {T}_{env} ( t ) , {T}_{out} ( t ) )} ) ;$$
$$COP ( {T}_{env} ( t ) , {T}_{out} ( t ) ) = \frac{{T}_{out} ( t )}{{T}_{out} ( t ) - {T}_{env} ( t )} ;$$
$${R}_{pump} ( t , D ) = \frac{1}{D} {\int }_{t}^{t + D} {P}_{pump} ( t ) dt ;$$
wherein Q_{demand}(t) denotes a heat load demand at the moment t and is expressed in kW; C_{load} denotes a load heat capacity and is expressed in kWh/degree; ΔT(t) denotes a difference between a target temperature and an environmental temperature at the moment t and is expressed in degrees Celsius; COP(Tₑₙᵥ(t), Tₒᵤₜ(t)) denotes a performance coefficient of the ground source heat pump devices; Pₚᵤₘₚ(t) denotes a power of the ground source heat pump devices at the moment t and is expressed in kW; P_{pump,max} denotes a maximum power of the ground source heat pump devices and is expressed in kW; Rₚᵤₘₚ(t,D) denotes an average power of the ground source heat pump devices during the target electricity consumption regulation duration D and is expressed in kW; Tₑₙᵥ(t) denotes an environmental temperature at the moment t and is expressed in degrees Celsius; and Tₒᵤₜ(t) denotes an output temperature of the ground source heat pump devices at the moment t and is expressed in degrees Celsius.

8. The device of claim 7, wherein the one or more processors are further configured to perform the following steps:
separately displaying the response power information of the plurality of PEDF devices, the response power information of the plurality of smart lighting devices, the response power information of the plurality of thermal storage electric boiler devices, and the response power information of the plurality of ground source heat pump devices through a visual interface.

9. The device of claim 7, wherein aggregating the response power information of the plurality of energy devices of the same type according to the type information to generate the response power information of the plurality of energy subsystems comprises:
aggregating response power information of a plurality of PEDF devices to generate response power information of PEDF subsystems;
aggregating response power information of a plurality of smart lighting devices to generate response power information of smart lighting subsystems;
aggregating response power information of a plurality of thermal storage electric boiler devices to generate response power information of thermal storage electric boiler subsystems; and
aggregating response power information of a plurality of ground source heat pump devices to generate response power information of ground source heat pump subsystems.

10. The device of claim 7, wherein the one or more processors are further configured to perform the following steps:
in response to the initial electricity consumption regulation capability information not satisfying the target constraint condition, adjusting the initial weights corresponding to the plurality of energy subsystems until the target constraint condition is satisfied, thereby obtaining target weights; and
generating target electricity consumption regulation capability information for the target region according to the target weights and the response power information of the plurality of energy subsystems.

11. The device of claim 10, wherein the one or more processors are further configured to perform the following steps:
acquiring current electricity transaction information and carbon emission factor information for the target region; and
generating regulation resource consumption information by processing the target electricity consumption regulation capability information, the current electricity transaction information, and the carbon emission factor information.

12. The device of claim 11, wherein the one or more processors are further configured to perform the following steps:
in response to receiving an approval instruction for the regulation resource consumption information, sending feedback information to the power distribution network to indicate approval of accepting regulation; and
adjusting operating power of the plurality of energy devices according to the electricity consumption strategy so that the plurality of energy devices operate normally during the target electricity consumption regulation period.

13. A non-transitory computer-readable storage medium configured to store a computer program or instruction which, when executed by a processor, causes the processor to perform the following steps:
in response to receiving a power distribution regulation instruction from a power distribution network, acquiring type information of a plurality of energy devices within a target region, a target electricity consumption regulation period, and historical load information of the plurality of energy devices corresponding to the target electricity consumption regulation period, wherein the power distribution regulation instruction comprises a regulation moment and a regulation duration corresponding to execution of an electricity consumption regulation operation;
separately processing the historical load information of the plurality of energy devices and the target electricity consumption regulation period according to evaluation strategies for the electricity consumption regulation capabilities corresponding to the type information to generate response power information of the plurality of energy devices;
aggregating the response power information of the plurality of energy devices of a same type according to the type information to generate response power information of a plurality of energy subsystems;
generating initial electricity consumption regulation capability information for the target region according to the response power information of the plurality of energy subsystems and initial weights corresponding to the plurality of energy subsystems; and
in response to the initial electricity consumption regulation capability information satisfying a target constraint condition, generating the electricity consumption strategy for the target electricity consumption regulation period according to the response power information of the plurality of energy devices to satisfy minute-level dynamic regulation demands of the power distribution network during the target electricity consumption regulation period and ensure an safe operation of the plurality of energy devices within the target region during the target electricity consumption regulation period, wherein the target constraint condition comprises an electricity consumption safety constraint and a carbon emission constraint for the target region;
wherein separately processing the historical load information of the plurality of energy devices and the target electricity consumption regulation period according to the evaluation strategies for the electricity consumption regulation capabilities corresponding to the type information to generate the response power information of the plurality of energy devices comprises:
determining a target electricity consumption regulation duration according to the target electricity consumption regulation period;
generating response power information of a plurality of photovoltaics, energy storage, direct current, and flexibility (PEDF) devices by processing the target electricity consumption regulation duration and historical load information of the plurality of PEDF devices based on an evaluation strategy corresponding to the PEDF devices, wherein the response power information of the PEDF devices comprises:
$${P}_{pv} ( t ) = min ( {P}_{pv , max} , G \cdot A \cdot η ) ;$$
$${R}_{pv} ( t , D ) = \frac{1}{D} {\int }_{t}^{t + D} {P}_{pv} ( t ) dt ;$$
wherein Pₚᵥ(t) denotes a photovoltaic power output and is expressed in kW; G denotes a solar radiation intensity and is expressed in kW/m²; A denotes an effective area of a photovoltaic panel and is expressed in m²; η denotes a conversion efficiency of the photovoltaic panel; P_{pv,max} denotes a maximum photovoltaic power output and is expressed in kW; D denotes the target electricity consumption regulation duration and is expressed in s; t denotes a target electricity consumption regulation moment; and Rₚᵥ(t,D) denotes an average photovoltaic power output during the target electricity consumption regulation duration D and is expressed in kW;
$${P}_{b , c} ( t ) = min ( {P}_{b , c , max} , {P}_{pv} ( t ) - {P}_{load} ( t ) ) ;$$
$${P}_{b , d} ( t ) = min ( {P}_{b , d , max} , {P}_{load} ( t ) - {P}_{pv} ( t ) ) ;$$
$${R}_{b} ( t , D ) = \frac{1}{D} {\int }_{t}^{t + D} ( {P}_{b , c} ( t ) - {P}_{b , d} ( t ) ) dt ;$$
wherein P_{b,c}(t) denotes a charge power of an energy storage system and is expressed in kW; P_{b,d}(t) denotes a discharge power of the energy storage system and is expressed in kW; P_{b,c,max} denotes a maximum charge power of the energy storage system and is expressed in kW; P_{b,d,max} denotes a maximum discharge power of the energy storage system and is expressed in kW; P_{load}(t) denotes a load power at a moment t and is expressed in kW; and R_{b}(t,D) denotes an average power of the energy storage system during the target electricity consumption regulation duration D and is expressed in kW;
$${P}_{c} ( t ) = max ( 0 , min ( {P}_{c , max} , {P}_{v 2 g , charge} ( t ) ) ) ;$$
$${P}_{d} ( t ) = max ( 0 , min ( {P}_{d , max} , {P}_{v 2 g , discharge} ( t ) ) ) ;$$
$${R}_{V 2 G} ( t , D ) = \frac{1}{D} {\int }_{t}^{t + D} ( {P}_{d} ( t ) - {P}_{c} ( t ) ) dt ;$$
wherein P_{c}(t) denotes a charge power of a charging pile to an electric vehicle and is expressed in kW; P_{d}(t) denotes a discharge power of the electric vehicle to the power grid and is expressed in kW; P_{c,max} denotes a maximum charge power of the charging pile to the electric vehicle and is expressed in kW; P_{d,max} denotes a maximum discharge power of the electric vehicle to the power grid and is expressed in kW; P_{v2g,charge}(t) denotes a allowed charge power of the vehicle at the moment t and is expressed in kW; P_{v2g,discharge}(t) denotes a allowed discharge power of the vehicle at the moment t and is expressed in kW; and R_{V2G}(t,D) denotes an average power of the charging pile during the target electricity consumption regulation duration D and is expressed in kW; wherein the overall electricity consumption regulation power of the PEDF device is:
$$f ( {E}_{b} , {R}_{pv} , {R}_{b} , {R}_{V 2 G} , t , D ) = min ( {R}_{pv} ( t , D ) + {R}_{b} ( t , D ) + {R}_{V 2 G} ( t , D ) ;$$
generating response power information of a plurality of smart lighting devices by processing the target electricity consumption regulation duration and historical load information of the plurality of smart lighting devices based on an evaluation strategy corresponding to the smart lighting devices, wherein the response power information of the plurality of smart lighting devices comprises:
$${P}_{light} ( t ) = min ( {P}_{light , max} , {D}_{light} ( t ) ( \frac{{L}_{current} ( t )}{{L}_{max}} \cdot {F}_{demand} ( t ) \cdot {F}_{schedule} ( t ) ) ;$$
$${R}_{light} ( t , D ) = \frac{1}{D} {\int }_{t}^{t + D} {P}_{light} ( t ) dt ;$$
wherein P_{light}(t) denotes a lighting power at the moment t and is expressed in kW; P_{light,max} denotes a maximum power of a light and is expressed in kW; D_{light}(t) denotes a lighting demand at the moment t and is expressed in kW; L_{current}(t) denotes an actual luminous intensity at the moment t and is expressed in lm; Lₘₐₓ denotes a maximum luminous intensity of the light and is expressed in lm; F_{demand}(t) denotes a demand response coefficient at the moment t, indicating a degree of a grid load response; F_{schedule}(t) denotes a time scheduling factor at the moment t; and R_{light}(t,D) denotes an average power of a smart lighting device during the target electricity consumption regulation duration D and is expressed in kW;
wherein when the target region participates in grid regulation, a demand response power is adjusted according to the following formula:
$${P}_{demand\_response} ( t , D ) = {P}_{current} ( t ) - {R}_{light} ( t , D ) ;$$
wherein P_{demand_response}(t,D) denotes a demand response power at the moment t and is expressed in kW; and P_{current}(t) denotes an actual lighting power at the moment t and is expressed in kW;
wherein when the target region participates in grid regulation, a time-scheduled power of the smart lighting system is shown by the following formula:
$${P}_{schedule\_adjusted} ( t , D ) = {P}_{demand\_response} ( t , D ) \cdot {F}_{schedule} ( t ) ;$$
wherein P_{schedule_adjusted}(t,D) denotes a power adjusted according to the time schedule at the moment t and is expressed in kW;
generating response power information of a plurality of thermal storage electric boiler devices by processing the target electricity consumption regulation duration and historical load information of the plurality of thermal storage electric boiler devices based on an evaluation strategy corresponding to the thermal storage electric boiler devices;
$${P}_{boiler} ( t ) = min ( {P}_{boiler , max} , {P}_{demand} ( t ) ) ;$$
$${P}_{demand} ( t ) = max ( 0 , \frac{( {T}_{target} - {T}_{env} ( t ) \cdot {C}_{load}}{{η}_{boiler}} - {E}_{boiler} ( t ) \cdot \frac{1}{{η}_{boiler}} ) ;$$
$${R}_{boiler} ( t , D ) = \frac{1}{D} {\int }_{t}^{t + D} {P}_{boiler} ( t ) dt ;$$
wherein P_{boiler}(t) denotes a power of an electric boiler at the moment t and is expressed in kW; P_{boiler,max} denotes a maximum power output of the electric boiler and is expressed in kW; P_{demand}(t) denotes a heat load demand of the electric boiler and is expressed in kW; T_{target} denotes a desired indoor temperature and is expressed in degrees Celsius; Tₑₙᵥ(t) denotes an environmental temperature at the moment t and is expressed in degrees Celsius; C_{load} denotes a load heat capacity and is expressed in kWh/degree; η_{boiler} denotes a thermal efficiency of the electric boiler; E_{boiler}(t) denotes stored heat at the moment t and is expressed in kWh; and R_{boiler}(t,D) denotes an average power of the thermal storage electric boiler devices during the target electricity consumption regulation duration D and is expressed in kW; and
generating response power information of a plurality of ground source heat pump devices by processing the target electricity consumption regulation duration and historical load information of the plurality of ground source heat pump devices based on an evaluation strategy corresponding to the ground source heat pump devices;
$${Q}_{demand} ( t ) = {C}_{load} \cdot Δ T ( t ) ;$$
$${P}_{pump} ( t ) = min ( {P}_{pump , max} , \frac{{Q}_{demand} ( t )}{COP ( {T}_{env} ( t ) , {T}_{out} ( t ) )} ) ;$$
$$COP ( {T}_{env} ( t ) , {T}_{out} ( t ) ) = \frac{{T}_{out} ( t )}{{T}_{out} ( t ) - {T}_{env} ( t )} ;$$
$${R}_{pump} ( t , D ) = \frac{1}{D} {\int }_{t}^{t + D} {P}_{pump} ( t ) dt ;$$
wherein Q_{demand}(t) denotes a heat load demand at the moment t and is expressed in kW; C_{load} denotes a load heat capacity and is expressed in kWh/degree; ΔT(t) denotes a difference between a target temperature and an environmental temperature at the moment t and is expressed in degrees Celsius; COP(Tₑₙᵥ(t),Tₒᵤₜ(t)) denotes a performance coefficient of the ground source heat pump devices; Pₚᵤₘₚ(t) denotes a power of the ground source heat pump devices at the moment t and is expressed in kW; P_{pump,max} denotes a maximum power of the ground source heat pump devices and is expressed in kW; Rₚᵤₘₚ(t,D) denotes an average power of the ground source heat pump devices during the target electricity consumption regulation duration D and is expressed in kW; Tₑₙᵥ(t) denotes an environmental temperature at the moment t and is expressed in degrees Celsius; and Tₒᵤₜ(t) denotes an output temperature of the ground source heat pump devices at the moment t and is expressed in degrees Celsius.

14. The storage medium of claim 13, wherein the processor is further configured to perform the following steps:
separately displaying the response power information of the plurality of PEDF devices, the response power information of the plurality of smart lighting devices, the response power information of the plurality of thermal storage electric boiler devices, and the response power information of the plurality of ground source heat pump devices through a visual interface.

15. The storage medium of claim 13, wherein aggregating the response power information of the plurality of energy devices of the same type according to the type information to generate the response power information of the plurality of energy subsystems comprises:
aggregating response power information of a plurality of PEDF devices to generate response power information of PEDF subsystems;
aggregating response power information of a plurality of smart lighting devices to generate response power information of smart lighting subsystems;
aggregating response power information of a plurality of thermal storage electric boiler devices to generate response power information of thermal storage electric boiler subsystems; and
aggregating response power information of a plurality of ground source heat pump devices to generate response power information of ground source heat pump subsystems.

16. The storage medium of claim 13, wherein the processor is further configured to perform the following steps:
in response to the initial electricity consumption regulation capability information not satisfying the target constraint condition, adjusting the initial weights corresponding to the plurality of energy subsystems until the target constraint condition is satisfied, thereby obtaining target weights; and
generating target electricity consumption regulation capability information for the target region according to the target weights and the response power information of the plurality of energy subsystems.

17. The storage medium of claim 16, wherein the processor is further configured to perform the following steps:
acquiring current electricity transaction information and carbon emission factor information for the target region; and
generating regulation resource consumption information by processing the target electricity consumption regulation capability information, the current electricity transaction information, and the carbon emission factor information.

18. The storage medium of claim 17, wherein the processor is further configured to perform the following steps:
in response to receiving an approval instruction for the regulation resource consumption information, sending feedback information to the power distribution network to indicate approval of accepting regulation; and
adjusting operating power of the plurality of energy devices according to the electricity consumption strategy so that the plurality of energy devices operate normally during the target electricity consumption regulation period.
